(19) United States
(12) Patent Application Publication
(10) Pub. No.: US 2005/0033542 A1
(43) Pub. Date: Feb. 10, 2005

(54) Debugger apparatus and debugging method

(75) Inventors: Toru Morikawa, Osaka (JP); Kazuhide Watanabe, Osaka (JP); Shinya Miyaji, Nara (JP)

Correspondence Address: McDERMOTT, WILL & EMERY, 600 13th Street, N.W., Washigton, DC, 20005-3096, US

(73) Assignee: MATSUSHITA ELECTRIC INDUSTRIAL CO., LTD.

(21) Appl. No.: 10/899,101

(22) Filed: Jul. 27, 2004

(30) Foreign Application Priority Data
Aug. 4, 2003 (JP) P2003-286061

(51) Int. Cl. G06F 19/00

(52) U.S. Cl. 702/118

(57) ABSTRACT

A debugger apparatus according to the present embodiment comprises a host, CPU, a plurality of E-memory units (emulation memory units) for storing instructions, and an execution supervision unit. The host traces the instructions to be stored in the E-memory units and transfers the tracing result in the form of an instruction sequence. The execution supervision unit is connected to the CPU, E-memory units, and host. The execution supervision unit individually writes the instruction sequences transferred from the host in the plurality of E-memory units, reads an instruction sequence from one of the plurality of E-memory units in accordance with an instruction address of the CPU to thereby transfer the instruction sequence to the CPU, and outputs an instruction rewriting order to the host when the instruction address of the CPU is irrelevant.

### BACKGROUND OF THE INVENTION

The present invention relates to a debugger apparatus configured in the manner that an instruction supplied to a system LSI of a host PC is temporarily stored in an E-memory (emulation memory) to be thereafter supplied from the E-memory to a CPU.

In an in-circuit emulator (ICE), which is an example of a conventional debugger apparatus, a debug monitor program is written in a built-in memory such as a cash memory, and the instruction for the CPU is emulated. Problems in the foregoing process are, if an inter-chip delay is large, because the system LSI and the ICE are different chips, itis not possible to emulate the instruction; incorporating the ICE in the system LSI invites an increase in area; the use of the built-in memory results in a shortage of capacity; a built-in ROM cannot be debugged in the case of downloading the monitor program from an external ROM; and an instruction-incorporated ROM cannot be emulated.

### SUMMARY OF THE INVENTION

Therefore, a main object of the present invention is to provide a debugger apparatus capable of efficiently writing an instruction in an E-memory, controlling an overhead resulting from transfer traffic, and efficiently supplying the instruction to a CPU, while controlling an area increase.

Other objects, features and advantages of the invention will become clear by the following description.

Hereinafter, components of a plurality of types will be described. The components may be comprised of software, hardware, or a combination of hardware and software.

An emulation memory unit serves to temporarily store the instructions executed by the CPU and abbreviated to E-memory unit in the description that follows.

An E-memory execution supervision unit is connected to the CPU, E-memory unit, and a host PC to thereby relay a control signal and data among the foregoing three components and abbreviated to execution supervision unit. The host PC is abbreviated to host.

1. A debugger apparatus according to the present invention comprises:

a plurality of E-memory units, the plurality of E-memory units storing instructions executed by a CPU; and
an execution supervision unit connected to the CPU, E-memory units, and host,
the execution supervision unit being configured in the following manner: instruction sequences transferred from the host are individually written in the plurality of E-memory units, and an instruction sequence is read from one of the plurality of E-memory units and transferred to the CPU in accordance with an instruction address of the CPU. When the instruction address of the CPU is irrelevant, an instruction rewriting order is outputted to the host.

In the foregoing configuration, the instructions are previously traced in the host according to the execution sequence, results of which are sequentially transferred to the plurality of E-memory units to be stored therein. In this manner, the instructions can be more efficiently written in the E-memory units, while controlling the overhead resulting from the transfer traffic, thereby efficiently supplying the CPU with the instructions.

2. A debugger apparatus according to the present invention comprises:

A CPU, the CPU executing instructions;
a plurality of E-memory units, the plurality of E-memory units storing the instructions executed by the CPU;
a host, the host tracing the instructions to be stored in the E-memory units and transferring the tracing result in the form of an instruction sequence; and
an execution supervision unit connected to the CPU, E-memory units, and host,
the execution supervision unit being configured in the following manner: the instruction sequences transferred from the host are individually written in the plurality of E-memory units, and an instruction sequence is read from one of the plurality of E-memory units and transferred to the CPU in accordance with the instruction address of the CPU. When the instruction address of the CPU is irrelevant, the instruction rewriting order is outputted to the host.

In the foregoing configuration, when a required instruction is not stored in the E-memory unit, the switchover of the E-memory units is implemented and the instruction rewriting order is outputted. Then, an instruction sequence to be subsequently executed is read from the host and stored in the currently-unused E-memory unit. In this manner, the overhead resulting from the transfer traffic can be controlled, thereby efficiently supplying the CPU with the instructions.

3. A debugger apparatus according to the present invention comprises:

a CPU, the CPU executing instructions;
a plurality of E-memory units, the plurality of E-memory units storing the instructions to be executed by the CPU;
a host, the host tracing the instructions to be stored in the E-memory units and transferring the tracing result in the form of an instruction sequence; and
an execution supervision unit connected to the CPU, E-memory units, and host,
the execution supervision unit being configured in the following manner: the instruction sequences transferred from the host are individually written in the plurality of E-memory units, and an instruction sequence is read from one of the plurality of E-memory units and transferred to the CPU in accordance with the instruction address of the CPU. When the instructions in accordance with the instruction address of the CPU represent the execution of an unconditional branch instruction, the instruction rewriting order is outputted to the host.

In the foregoing configuration, the instructions are previously traced in the host according to the execution sequence, and the instructions prior to the unconditional branch and the instructions from the unconditional branch destination instruction onwards are respectively transferred to and stored in the plurality of E-memory units independent from each other. Then, the switchover of the E-memory units is implemented when the unconditional branch instruction is executed. In this manner, the overhead resulting from the transfer traffic can be thus controlled, thereby efficiently supplying the CPU with the instructions.

4. A debugger apparatus according to the present invention is configured in the following manner.

The instructions are traced in the host according to the execution sequence, and when a branch destination of the unconditional branch instruction falls under a memory region of the same E-memory unit, a plurality of instruction sequences fitting into the same E-memory unit are written in the same E-memory unit by the execution supervision unit. The CPU outputs an address of the unconditional branch instruction to the execution supervision unit. The execution supervision unit judges, in accordance with the instruction address of the CPU, whether or not the E-memory unit currently read by the unconditional branch instruction is the same as the previously read E-memory unit, and when it is judged that they are the same, the output of the instruction rewriting order is terminated.

In the foregoing configuration, when the instructions are previously traced in the host according to the execution sequence, it is judged whether or not the branch destination thereof falls under a memory capacity of the E-memory unit. When the branch destination is judged to do so, the branch destination is not handled as a different instruction sequence. In this manner, it becomes unnecessary to additionally transfer the instructions and to write them in the E-memory unit for the purpose of branching. Therefore, the overhead resulting from the transfer traffic can be controlled, thereby efficiently supplying the CPU with the instructions.

5. A debugger apparatus according to the present invention comprises:

a CPU, the CPU executing instructions;
a plurality of E-memory units, the plurality of E-memory units storing the instructions executed by the CPU;
a host, the host tracing the instructions to be stored in the E-memory units and transferring the tracing result in the form of an instruction sequence; and
an execution supervision unit connected to the CPU, E-memory units, and host,
the execution supervision unit being configured in the following manner: the instruction sequences transferred from the host are individually written in the plurality of E-memory units, and an instruction sequence is read from one of the plurality of E-memory units and transferred to the CPU in accordance with the instruction address of the CPU. When the instructions in accordance with the instruction address of the CPU represent the execution of the unconditional branch instruction, the instruction rewriting order is outputted to the host, and when the instructions in accordance with the instruction address of the CPU represent the execution of a subroutine call instruction, the output of the instruction rewriting order is terminated.

According to foregoing configuration, in the case of branching by the subroutine call instruction, a subroutine branch information is retained, and the instruction sequence in a branch origin is not changed when branched by the subroutine call instruction. This successfully controls the overhead resulting from the transfer traffic in additionally transferring and writing the instructions with respect to the E-memory unit, thereby efficiently supplying the CPU with the instructions.

6. A debugger apparatus according to the present invention comprises:

a CPU, the CPU executing instructions;
a plurality of E-memory units, the plurality of E-memory units storing the instructions executed by the CPU;
a host, the host tracing the instructions to be stored in the E-memory units and transferring the tracing result in the form of an instruction sequence; and
an execution supervision unit connected to the CPU, E-memory units, and host,
the execution supervision unit being configured in the following manner: the instruction sequences transferred from the host are individually written in the plurality of E-memory units, and an instruction sequence is read from one of the plurality of E-memory units and transferred to the CPU in accordance with the instruction address of the CPU. When the instructions in accordance with the instruction address of the CPU represent the execution of the unconditional branch instruction, the instruction rewriting order is outputted to the host, and when the instructions in accordance with the instruction address represent the execution of an exception processing, the output of the instruction rewriting order is terminated.

In the foregoing configuration, when the exception processing such as interruption occurs, the exception processing is retained, and the instruction sequence in the branch origin is not changed when branched by the exception processing. This successfully controls the overhead resulting from the transfer traffic in additionally transferring and writing the instructions with respect to the E-memory unit, thereby efficiently supplying the CPU with the instructions.

7. A debugger apparatus according to the present invention comprises:

a CPU, the CPU executing instructions;
a plurality of E-memory units, the plurality of E-memory units storing the instructions executed by the CPU;
a host, the host tracing the instructions to be stored in the E-memory units and transferring the tracing result in the form of an instruction sequence; and
an execution supervision unit connected to the CPU, E-memory units, and host,
the execution supervision unit being configured in the following manner: the instruction sequences transferred from the host are individually written in the plurality of E-memory units, and an instruction sequence is read from one of the plurality of E-memory units in accordance with the instruction address of the CPU to be thereby transferred to the CPU. When the instructions in accordance with the instruction address of the CPU represent the execution of a conditional branch instruction, it is judged whether or not the branch is established, and when the branch is judged to be established, the instruction rewriting order is outputted to the host.

In the foregoing configuration, when the conditional branch instruction is included in the instruction sequence, the instruction sequence in the branch destination becomes necessary or unnecessary depending on the establishment or failure of the conditional branch instruction. In either case, established or failed, the unnecessary instruction sequence is rewritten into the subsequent necessary instruction sequence. This achieves the control of the overhead resulting from the transfer traffic in additionally transferring and writing the instructions with respect to the E-memory unit, thereby efficiently supplying the CPU with the instructions.

8. A debugger apparatus according to the present invention comprises a host functioning in the following manner.

The instructions to be executed by the CPU are traced according to the execution sequence, and the traced instructions are simulated. When the simulation result represents the presence of the conditional branch instruction, it is predicted if the branch is established or failed. When it is predicted that the branch is failed, the transfer of the instruction sequence of the branch destination with respect to the execution supervision unit is terminated.

In the foregoing configuration, when the instructions to be executed are previously traced in the host, the instruction sequences are simulated, and it is thereby predicted if the branch is established or failed by retaining values of an internal register, or the like. This achieves the control of the overhead resulting from the transfer traffic in additionally transferring and writing the instructions with respect to the E-memory unit, thereby efficiently supplying the CPU with the instructions.

9. A debugger apparatus according to the present invention comprises:

a CPU, the CPU executing instructions;
a plurality of E-memory units, the plurality of E-memory units storing the instructions executed by the CPU;
a host, the host tracing the instructions to be stored in the E-memory units, transferring the result in the form of an instruction sequence, andpossibly transferring instruction sequences each including a plurality of conditional branch instructions; and
an execution supervision unit connected to the CPU, E-memory units, and host,
the execution supervision unit being configured in the following manner: the instruction sequences transferred from the host are individually written in the plurality of E-memory units, and an instruction sequence is read from one of the plurality of E-memory units in accordance with the instruction address of the CPU to be thereby transferred to the CPU. When the instructions in accordance with the instruction address of the CPU represent the execution of a first conditional branch instruction of the plurality of conditional branch instructions, it is judged whether or not the branch is established. When the branch is judged to be established, the instruction rewriting order is outputted to the host, and when the branch is judged to be failed, the output of the instruction rewriting order is terminated. A technical feature in the foregoing configuration is the inclusion of the plurality of conditional branch instructions in each instruction sequence.

In the foregoing configuration, when the plurality of conditional branch instructions are included in the instruction sequences, addresses of the plurality of conditional branch instructions are retained in, for example, FIFO (First-In, First-Out) to be shifted each time when the branch is failed. When the branch is established, the content of the FIFO is cleared. In this manner, the overhead resulting from the transfer traffic generated when additionally transferring and writing the instructions with respect to the E-memory unit can be controlled, thereby efficiently supplying the CPU with the instructions.

10. A debugger apparatus according to the present invention comprises:

a CPU, the CPU executing instructions;
a plurality of E-memory units, the plurality of E-memory units storing the instructions executed by the CPU;
a host, the host tracing the instructions to be stored in the E-memory units and transferring the tracing result in the form of an instruction sequence; and
an execution supervision unit connected to the CPU, E-memory units, and host,
the execution supervision unit being configured in the following manner: the instruction sequences per task transferred from the host are individually written in the plurality of E-memory units, and an instruction sequence of a task is read from one of the plurality of E-memory units in accordance with the instruction address of the CPU to be thereby transferred to the CPU. When the instructions in accordance with the instruction address of the CPU represent the execution of a task switchover, the instruction rewriting order is outputted to the host.

In the foregoing configuration, the instruction sequences are previously divided per task of OS (operating system) in the host so that the instruction sequence per task is transferred to and stored in the E-memory units, and the switchover of the E-memory units is implemented when the tasks are switched over. In this manner, the overhead resulting from the transfer traffic in additionally transferring and writing the instructions with respect to the E-memory unit can be controlled, thereby efficiently supplying the CPU with the instructions.

11. A debugger apparatus according to the present invention is configured in the manner:

the host traces the instructions executed by the CPU according to the execution sequence and thereby produces an execution tree construction,
the host divides the instruction sequences into the branch destination and branch origin of the branch instruction based on the tree construction to thereby transfer the instructions per instruction sequence to the execution supervision unit, and
the execution supervision unit sequentially writes the instructions transferred from the host per instruction sequence in the plurality of E-memory units.

In the foregoing configuration, all the instructions to be executed are previously traced in the host to thereby detect spots (node part) where a disturbance of a program manipulation is generated, and addresses of the detected node parts and byte numbers between the node parts are recorded as the tree construction. In this manner, it becomes unnecessary to execute rewriting with respect to the E-memory units in accordance with an analysis of behaviors of the respective instructions by the program. Therefore, the overhead resulting from the analysis can be controlled, thereby efficiently supplying the CPU with the instructions.

12. A debugger apparatus according to the present invention comprises:

a CPU, the CPU executing instructions;
a single E-memory unit, the single E-memory unit storing the instructions executed by the CPU;
a host, the host tracing the instructions to be stored in the E-memory unit and transferring the tracing result in the form of an instruction sequence together with a write leading address; and
an execution supervision unit connected to the CPU, E-memory unit, and host,
the execution supervision unit being configured in the following manner: the write leading address transferred from the host is retained, and the instruction sequence transferred from the host is written in the E-memory unit in accordance with the write leading address. The write leading address and a leading instruction address transferred from the host are retained, and the instruction address of the CPU is converted into an address for accessing the E-memory unit based on the write leading address and leading instruction address. The instructions are read from the E-memory unit based on the converted address to be thereby transferred to the CPU. When the instructions in accordance with the instruction address of the CPU represent the execution of the branch instruction, an address rewriting order is outputted to the host, and the write leading address and leading instruction address of the instruction sequence to be subsequently executed, which are transferred from the host in response to the address rewriting order, are retained. A technical feature in the foregoing configuration is that a single E-memory unit is comprised.

According to the foregoing configuration, the host transfers the writing leading address at the time of writing the instructions in the E-memory unit, and further transfers the writing leading address and leading instruction address at the time of reading the instructions from the E-memory unit. In this manner, the writing and reading with respect to the E-memory unit can be implemented in a continuous space, thereby achieving an effective use of the single E-memory unit.

13. A debugger apparatus according to the present invention comprises:

a CPU, the CPU executing instructions;
a single E-memory unit, the single E-memory unit storing the instructions executed by the CPU;
a host, the host tracing the instructions to be stored in the E-memory unit and transferring the tracing result in the form of an instruction sequence together with a write leading address; and
an execution supervision unit connected to the CPU, E-memory unit, and host,
the execution supervision unit being configured in the following manner: the write leading address transferred from the host is retained, and the instruction sequence transferred from the host is written in the E-memory unit in accordance with the write leading address. The write leading address and leading instruction address, and the write leading address and leading instruction address of the instruction sequence to be possibly subsequently executed, which are transferred from the host, are retained, and the instruction address of the CPU is converted into the address for accessing the E-memory unit based on the write leading address and leading instruction address. The instructions are read from the E-memory unit based on the converted address to be thereby transferred to the CPU. When the instructions in accordance with the instruction address of the CPU represent the execution of the branch instruction, the current write leading address is replaced by the subsequent write leading address, and the current leading instruction address is also replaced by the subsequent leading instruction address. Then, the address rewriting order is outputted to the host, and the writing leading address and leading instruction address of the instruction sequence to be subsequently executed, which are transferred from the host in response to the address rewriting order, are respectively retained as a next choice.

In the foregoing configuration, the write leading address and leading instruction address are both retained, and replaced by the subsequent write leading address and leading instruction address at the time of branching. In this manner, the overhead resulting from additionally transferring the addresses at the time of branching is controlled.

The foregoing and other aspects will become apparent from the following description of the invention when considered in conjunction with the accompanying drawing figures.

### BRIEF DESCRIPTION OF THE DRAWINGS

FIG. 1 is a block diagram illustrating a configuration of a debugger apparatus according to an embodiment of the present invention.

FIG. 2 is a block diagram illustrating a configuration of an execution supervision unit according to the embodiment 1.

FIG. 3 is a view of instruction sequences, which are stored in a first 1E memory and a second 2E memory and subsequently processed by a CPU according to the embodiment 1.

FIG. 4 is a block diagram illustrating a configuration of an execution supervision unit according to an embodiment 2 of the present invention.

FIG. 5 is a view of instruction sequences, which are stored in a first 1E memory and a second 2E and subsequently processed by a CPU memory according to the embodiment 2.

FIG. 6 is a view of instruction sequences including unconditional branch instructions according to an embodiment 3 of the present invention.

FIG. 7 is a block diagram illustrating a configuration of an execution supervision unit according to an embodiment 4 of the present invention.

FIG. 8 is a view of instruction sequences, which are stored in a first 1E memory and a second 2E memory and subsequently processed by a CPU according to the embodiment 4.

FIG. 9 is a view of instruction sequences, which are subject to a subroutine branch, from an instruction sequence 1 to an instruction sequence 2 according to the embodiment 4.

FIG. 10 is a block diagram illustrating a configuration of an execution supervision unit according to an embodiment 5 of the present invention.

FIG. 11 is a view of instruction sequences, which are stored in a first 1E memory and a second 2E memory and subsequently processed by a CPU according to the embodiment 5.

FIG. 12 is a block diagram illustrating a configuration of an execution supervision unit according to an embodiment 6 of the present invention.

FIG. 13 is a view of instruction sequences, which are stored in a first 1E memory and a second 2E memory and subsequently processed by a CPU according to the embodiment 6.

FIG. 14 is a block diagram illustrating a configuration of an execution supervision unit according to an embodiment 7 of the present invention.

FIG. 15 is a view of instruction sequences, which are stored in a first 1E memory and a second 2E memory and subsequently processed by a CPU according to the embodiment 7.

FIG. 16 is a view of a simulation prediction result and instruction sequences processed by a CPU according to an embodiment 8 of the present invention.

FIG. 17 is a view of a simulation prediction result and instruction sequences processed by a CPU according to the embodiment 8.

FIG. 18 is a block diagram illustrating a configuration of an execution supervision unit according to an embodiment 9 of the present invention.

FIG. 19 shows tasks processed by a CPU according to the embodiment 9.

FIG. 20 is a branch-related tree construction produced in a host according to an embodiment 10 of the present invention.

FIG. 21 is a block diagram illustrating a configuration of a debugger apparatus according to an embodiment 11 of the present invention.

FIG. 22 is a block diagram illustrating a configuration of an execution supervision unit according to the embodiment 11.

FIG. 23 is a view of instruction sequences, which are stored in a first 1E memory and a second 2E memory and subsequently processed by a CPU according to the embodiment 11.

FIG. 24 is a block diagram illustrating a configuration of an execution supervision unit according to an embodiment 12 of the present invention.

In all these figures, like components are indicated by the same numerals.

### DETAILED DESCRIPTION

Hereinafter, preferred embodiments of the present invention are described referring to the drawings

Embodiment 1

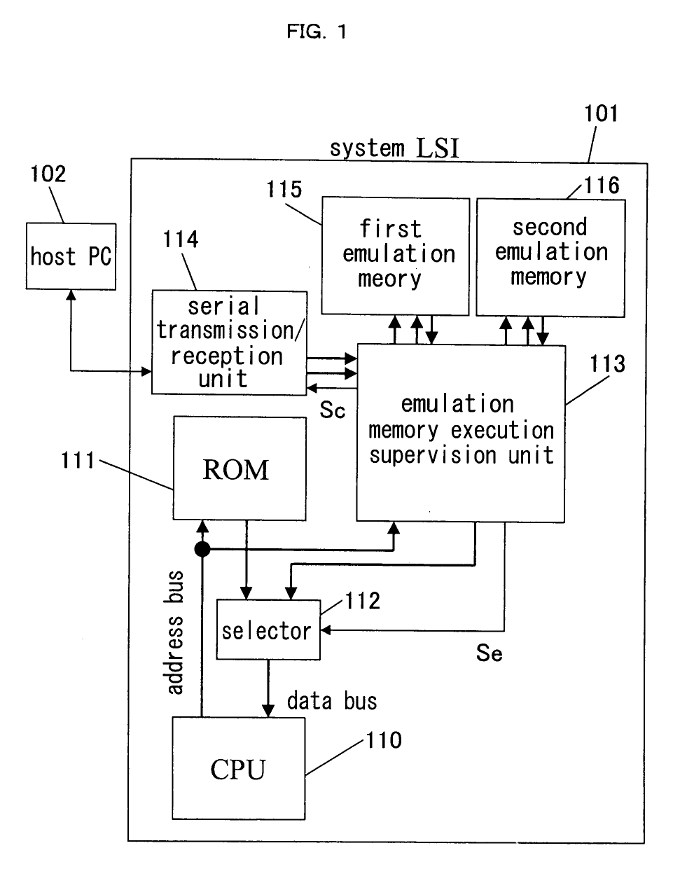

As shown in FIG. 1, a system LSI 101 comprises a CPU 110, ROM 111, selector 112, emulation memory execution supervision unit 113, serial transmission/reception unit 114, first emulation memory 115, and second emulation memory 116. Hereinafter, the emulation memory execution supervision unit is abbreviated to execution supervision unit, the serial transmission/reception unit to transmission/reception unit, the first emulation memory to first E-memory, and the second emulation memory to second E-memory. A host PC (hereinafter, abbreviated to host) 102 is a computer, wherein a debugger software capable of serial transmission and reception with respect to the transmission/reception unit 114 is installed.

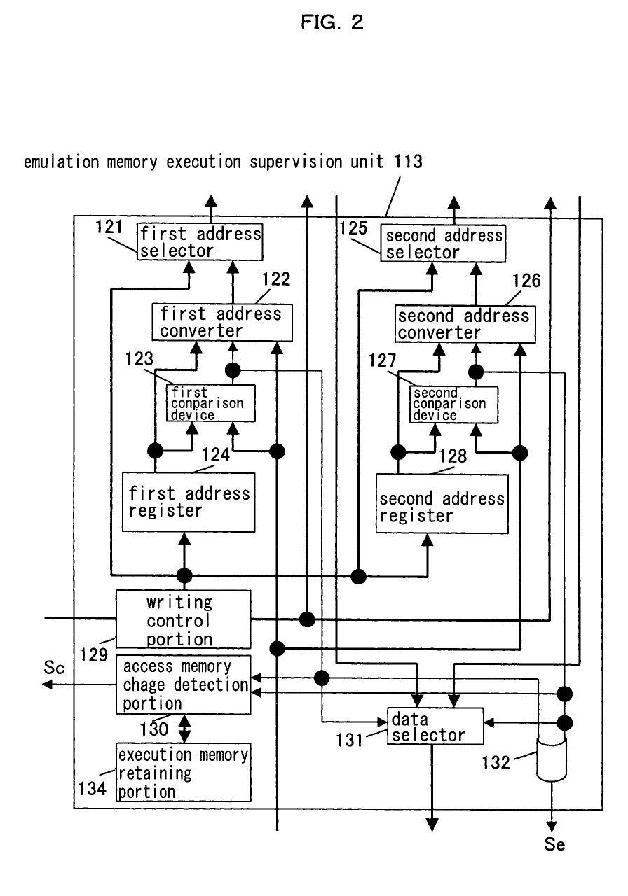

As shown in FIG. 2, the execution supervision unit 113 comprises a first address selector 121, a first address converter 122, first comparison device 123, first address register 124, second address selector 125, second address converter 126, second comparison device 127, second address register 128, writing control portion 129, access memory change detection portion 130, data selector 131, logical sum circuit 132, and execution memory retaining portion 134. Hereinafter, the first address selector is abbreviated to first selector, the first address converter to first converter, the first address register to first register, the second address selector to second selector, the second address converter to second converter, the second address register to second register, the access memory change detection portion to change detection portion, and the logical sum circuit to OR circuit.

The transmission/reception unit 114 implements the serial transmission and reception with respect to the host, and transfers received instructions and an address of a leading instruction (hereinafter, abbreviated to leading address) to the execution supervision unit 113 in the form of parallel data, while transmitting an instruction rewriting order Sc inputted from the execution supervision unit 113 to the host in the form of serial data.

The execution supervision unit 113 writes the instructions received from the host 102 via the transmission/reception unit 114 in the first E-memory 115 and the second E-memory 116, and transmits the instructions read from the first E-memory 115 and second E-memory 116 to the selector 112, while outputting a selection signal Se.

The first E-memory 115 and the second E-memory 116 are accessed in accordance with the address from the execution supervision unit 113 to thereby read and write data.

The selector 112 selects the data of the ROM 111 when the selection signal Se from the execution supervision unit 113 is “L”, and selects the data from the execution supervision unit 113 when the selection signal Se is “H”. In accordance with the instruction address outputted by the CPU, the ROM 111 is accessed, or the first E-memory 115 or the second E-memory 116 is accessed via the execution supervision unit 113. The read-out instructions are supplied from the selector 112, and the CPU 110 executes the instructions.

The writing control portion 129 inputs the instructions and leading address from the transmission/reception unit 114 therein, writes the leading address in the first register 124 or second register 128, and outputs the instructions equivalent to a memory capacity of the first E-memory 115 or second E-memory 116 to the first selector 121 or second selector 125.

The first register 124 and second register 128 store the leading address from the writing control portion 129.

The comparison device 123 inputs the leading address from the first register 124 and instruction address from the CPU 110 therein, and judges whether or not the instruction address corresponds to a memory region of the first E-memory 115. The second comparison device 127 inputs the leading address from the second register 128 and instruction address from the CPU 110 therein, and judges whether or not the instruction address corresponds to a memory region of the second E-memory 116.

The first converter 122, when the judgment result of the first comparison device 123 shows positive, converts the instruction address of the CPU into an address for accessing the first E-memory 115 based on the leading address of the first register 124. Further, the second converter 126, when the judgment result of the second comparison device 127 shows positive, converts the instruction address of the CPU into an address for accessing the second E-memory 116 based on the leading address of the second register 128.

The first selector 121 selects the address of the writing control portion 129 when the access with respect to the first E-memory 115 is writing, and selects the address converted by the first converter 122 otherwise.

The second selector 125 selects the address of the writing control portion 129 when the access with respect to the second E-memory 116 is writing, and selects the address converted by the second converter 126 otherwise.

The data selector 131 selects the data of the first E-memory 115 when the judgment result of the first comparison device 123 shows positive, and selects the data of the second E-memory 116 when the judgment result of the second comparison device 127 shows positive. The OR circuit 132 outputs a logical sum of the judgment results of the first and second comparison devices 123 and 127 in the form of the selection signal Se to the selector 112.

The change detection portion 130 activates the instruction rewriting order Sc and outputs it to the transmission/reception unit 114 when a currently-executed memory number is different to a memory number of the execution memory retaining portion 134 based on the judgment results of the first and second comparison devices 123 and 127. The execution memory retaining portion 134 receives the currently-executed memory number from the change detection portion 130 and retains it.

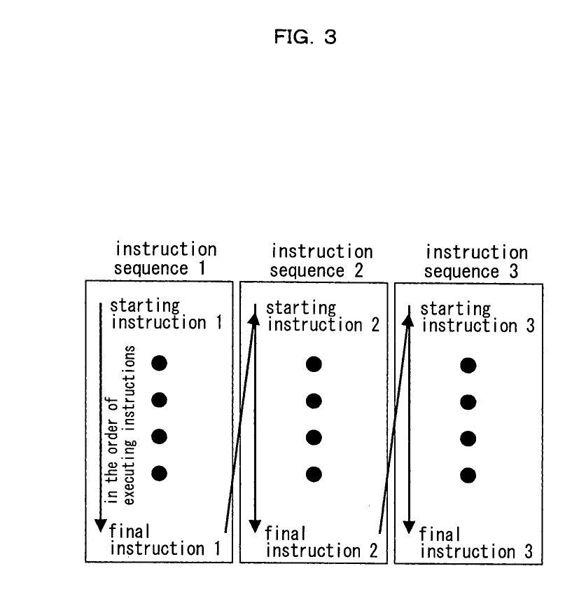

The operations of the debugger apparatus configured as above are described below. FIG. 3 shows instruction sequences transferred from the host. The instruction sequences are first stored in the first and second E-memories 115 and 116 to be thereafter executed by the CPU 110. The operations of the debugger apparatus are sectioned into three stages, 1, 2 and 3, and described below in that order.

1. Operation of Writing Instruction in E-Memory

The host traces the instructions, starting from the instruction first executed by the CPU 110, according to the execution sequence, and memorizes an instruction sequence number 1 and leading address thereof as an instruction sequence 1. A size of the instruction sequence 1 corresponds to the memory capacity of the first E-memory 115. Next, the host memorizes an instruction sequence number 2 and leading address thereof as an instruction sequence 2. A size of the instruction sequence 2 corresponds to the memory capacity of the second E-memory 116. In the same manner, the host memorizes instruction sequence numbers and leading addresses thereof that follow as an instruction sequence 3, instruction sequence 4 and thereafter.

The host converts the instructions and leading address of the instruction sequence 1 into the serial data, and transmits it to the transmission/reception unit 114. The transmission/reception unit 114 converts the received instructions and leading address of the instruction sequence 1 into the parallel data, and transfers it to the writing control portion 129. The writing control portion 129 writes the leading address in the first register 124. In this case, the first selector 121 sends out the address delivered from the writing control portion 129 to the first E-memory 115, and the first E-memory 115 is accessed based on the address so that the instructions of the instruction sequence 1 delivered from the writing control portion 129 are written therein.

Next, the host transfers the instruction and leading address of the instruction sequence 2 via the transmission/reception unit 114 to the writing control portion 129, and the writing control portion 129 writes the leading address in the second register 128. In this case, the second selector 125 sends out the address delivered from the writing control portion 129 to the second E-memory 116, and the second E-memory 116 is accessed based on the address so that the instructions of the instruction sequence 2 delivered from the writing control portion 129 are written therein.

2. Operation of Executing Instruction Sequence 1

The CPU 110 outputs the instruction address of the instruction sequence 1. The first comparison device 123 compares the instruction address of the CPU to the leading address of the instruction sequence 1 of the first register 124 to thereby judge whether or not the instruction address corresponds to the memory region of the first E-memory 115. The judgment result here is positive. The first converter 122, because the judgment result of the first comparison device 123 shows positive, converts the instruction address into the address for accessing the first E-memory 115 based on the leading address of the instruction sequence 1. On the contrary, the judgment result of the second comparison device 127 shows negative, therefore the conversion of the instruction address is not implemented by the second converter 126.

The address converted by the first converter 122 is selected by the first selector 121 and transmitted to the first E-memory 115. The first E-memory 115 is accessed in accordance with the converted address and outputs the data to the data selector 131. The data selector 131, because the judgment result of the first comparison device 123 shows positive, selects the data from the first E-memory 115 and transmits it to the selector 112. Further, the OR circuit 132, because the judgment result of the first comparison device 123 shows positive, outputs the selection signal Se, that is “H”, to the selector 112. The selector 112, because the selection signal Se is “H”, selects the instructions read from the first E-memory 115 and transmits them to the CPU 110. The CPU 110 inputs the instructions read from the first E-memory 115 therein and executes them.

The change detection portion 130 writes “1”, that is the currently-executed memory number, in the execution memory retaining portion 134 from the judgment result of the first comparison device 123.

3. Operation When Shifting from Instruction Sequence 1 to Instruction Sequence 2

The CPU 110 outputs the instruction address of the instruction sequence 2. Processed as in the foregoing manner, the judgment result of the second comparison device 127 and the judgment result of the first comparison device 123 here are respectively positive and negative. The second converter 126, in the same manner as described earlier, converts the instruction address of the CPU into the address for accessing the second E-memory 116 based on the leading address of the instruction sequence 2. The CPU 110, as in the foregoing manner, inputs the instructions read from the second E-memory 116 therein and executes them.

The change detection portion 130, because the judgment result of the second comparison device 127 shows that the currently-executed memory number is “2”, which is different to the memory number “1” retained in the execution memory retaining portion 134, outputs the instruction rewriting order Sc to the transmission/reception unit 114, and further writes the currently-executed memory number “2” in the execution memory retaining portion 134.

The instruction rewriting order Sc is transmitted to the host in order to store the next instruction sequence 3 in the first E-memory 115 during the time when the instruction sequence 2 is being executed because the reading and execution of the instructions with respect to the first E-memory 115 are completed and the instructions of the instruction sequence 1 are already processed.

The transmission/reception unit 114 transmits the instruction rewriting order Sc to the host. The host, in receipt of the instruction rewriting order Sc, transfers and stores the next instruction sequence 3 with respect to the first E-memory 115 in the same manner as described.

When the reading and execution of the instruction sequence 2 are completed followed by the commencement of the reading and execution of the instruction sequence 3, the instruction rewriting order Sc is activated as in the same manner as described, the instruction sequence 4, which is subsequent to the instruction sequence 3 currently executed, is transferred to and stored in the second E-memory 116.

In the foregoing manner, the instructions are repeatedly stored alternately in the first E-memory 115 and second E-memory 116.

As described, according to the present embodiment, the instructions are previously traced in the host according to the execution sequence to thereby memorize the leading addresses of the instruction sequences so that the instruction sequences are transferred to and stored alternately in the first E-memory 115 and the second E-memory 116. In this manner, the writing with respect to the E-memories is efficiently performed, and an overhead resulting from transfer traffic can be controlled, thereby efficiently supplying the CPU with the instructions.

The present embodiment described the case of providing the two E-memories. When at lease three E-memories are provided, the frequency of instruction transfer during the time when the instructions are executed can be reduced. Further, in the present embodiment, the communication between the system LSI and the host employed the serial method, however, other communications methods, such as a parallel method, can be employed.

Embodiment 2

In the embodiment 1, when there is an unconditional branch instruction prior to a final line of the memory capacity of an E-memory, the destination of the transferred instruction sequence is, without using the entire region of the E-memory, switched over to the other E-memory. In doing so, the overhead resulting from the traffic in transferring the instructions is generated. An embodiment 2 of the present invention deals with the inconvenience. In the embodiment 2, FIG. 1 is incorporated therein by reference.

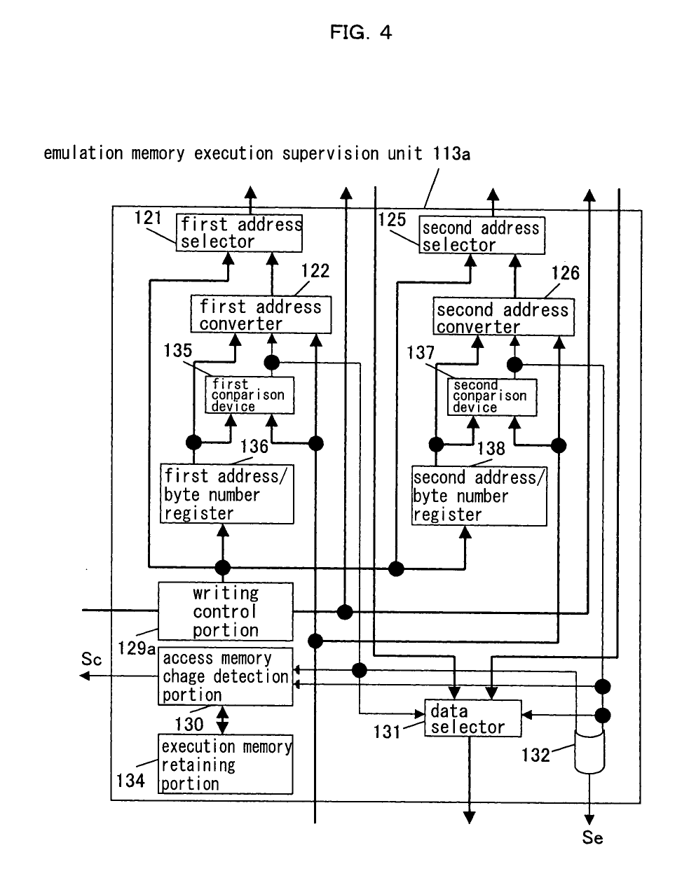

As shown in FIG. 4, an E-memory execution supervision unit 113a comprises a first address/byte number register 136 in place of the first register 124 in the embodiment 1 (FIG. 2), and a second address/byte number register 138 in place of the second register 128 therein. In the description below, the first address/byte number register is abbreviated to first register, and the second address/byte number register to second register. The first and second registers 136 and 138 store a leading address and transfer byte number from a writing control portion 129a. A reference numeral 135 denotes a first comparison device, and a reference numeral 137 denotes a second comparison device. Any other component in FIG. 4, which is identical to the component in FIG. 1, is simply provided with the same reference numeral and not described in the present embodiment.

The host transfers the transfer byte number of the instruction sequence in addition to the instructions and leading address thereof. The writing control portion 129a writes the leading address and transfer byte number inputted from the transmission/reception unit in the first and second registers 136 and 138. The writing control portion 129a further, while incrementing a writing address, transmits the instructions of the instruction sequence to the first selector 121 or second selector 125.

The first comparison device 135 inputs the leading address and transfer byte number of the first register 136 and instruction address of the CPU therein to thereby judge whether or not the instruction address falls within the transfer byte number from the leading address. The second comparison device 137 inputs the leading address and transfer byte number of the second register 138 and instruction address of the CPU therein to thereby judge whether or not the instruction address falls within the transfer byte number from the leading address.

When the judgment result of the first comparison device 135 shows positive, the first converter 122 converts the instruction address of the CPU into the address for accessing the first E-memory 115 based on the leading address and transfer byte number of the first register 136. When the judgment result of the second comparison device 137 shows positive, the second converter 126 converts the instruction address of the CPU into the address for accessing the second E-memory 116 based on the leading address and transfer byte number of the second register 138.

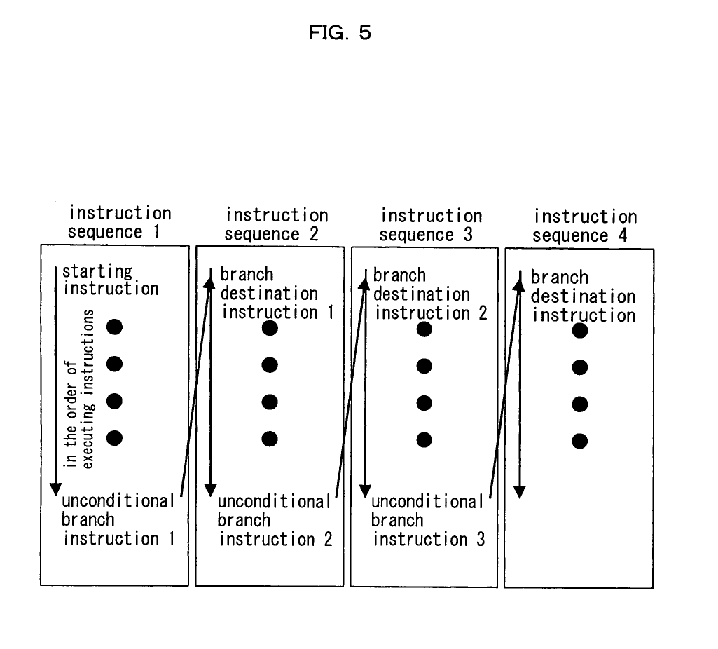

The operations of the debugger apparatus configured as above are described below. FIG. 5 shows instruction sequences transferred from the host. Each instruction sequence has the unconditional branch instruction therein.

1. Operation of Writing Instruction in E-Memory

The host traces the instructions, from the starting instruction, according to the execution sequence, divides the instructions into the instruction sequences per unconditional branch instruction, and memorizes the leading addresses of the instruction sequences. The host further memorizes the byte number of the instruction sequence as the transfer byte number, and for any other instruction sequence as well.

The host transfers the instructions, leading address, and transfer byte number of the instruction sequence 1 to the writing control portion 129a via the transmission/reception unit. The writing control portion 129a writes the leading address and transfer byte number in the first register 136. The first selector 121 transmits the address sent out from the writing control portion 129a to the firstE-memory 115. Based on the address, the first E-memory 115 is accessed so that the instructions of the instruction sequence 1 transmitted from the writing control portion 129a are written therein. The instructions, leading address and transfer byte number of the instruction sequence 2 are handled by means of the second register 138 and second selector 125 in the same manner so that the instructions of the instruction sequence 2 are written in the second E-memory 116.

2. Operation of Executing Instruction Sequence 1

The CPU outputs the instruction address of the instruction sequence 1. The first comparison device 135 inputs the instruction address of the CPU, and the leading address and transfer byte number of the first register 136 therein, and judges whether or not the instruction address of the CPU corresponds to the memory region of the first E-memory 115. The judgment result here shows positive and is outputted to the first converter 122. The first converter 122 converts the instruction address of the CPU into the address for accessing the first E-memory 115 based on the leading address and transfer byte number of the instruction sequence 1. On the contrary, the judgment result of the second comparison device 137 shows negative, therefore the conversion of the instruction address is not implemented by the second converter 126. Thereafter, the CPU inputs the instructions read from the first E-memory 115 and executes them in the same manner as described. The currently-executed memory number “1” is written in the execution memory retaining portion 134.

3. Operation When Branching by Unconditional Branch Instruction 1

When an unconditional branch instruction 1 arrives, the first comparison device 135 represents the judgment result as negative because the instruction address of the CPU does not fall within the transfer byte number from the leading address of the instruction sequence 1 of the first register 136. Therefore, the instruction address is not converted by the first converter 122.

On the contrary, the second comparison device 137 represents the judgment result as positive because the instruction address of the CPU falls within the transfer byte number from the leading address of the instruction sequence 2 of the second register 138. The second converter 126 converts the instruction address of the CPU into the address for accessing the second E-memory 116. Thereafter, the CPU inputs the instructions read from the first E-memory 116 and executes them in the same manner as described. Because the currently-executed memory number “2” is different to “1” in the execution memory retaining portion 134, the change detection portion 130 transmits the instruction rewriting order Sc.

The host, in receipt of the instruction rewriting order Sc, transfers the next instruction sequence 3 to the first E-memory 115 to be stored therein as in the foregoing manner.

4. Operation when Branching by Unconditional Branch Instruction 2

Upon the arrival of an unconditional branch instruction 2, the second comparison device 137 shows the judgment result as negative because the instruction address of the CPU does not fall within the transfer byte number from the leading address of the instruction sequence 2 of the second register 138. Therefore, there is no implementation of the instruction address conversion by the second converter 126.

On the contrary, the first comparison device 135 shows the judgment result as positive because the instruction address of the CPU falls within the transfer byte number from the leading address of the first register 136. The first converter 122 converts the instruction address of the CPU into the address for accessing the first E-memory 115 based on the leading address and transfer byte number of the instruction sequence 3. Thereafter, the CPU inputs the instructions read from the first E-memory 115 and executes them in the same manner as described. The currently-executed memory number “1” is different to “2” in the execution memory retaining portion 134, the change detection portion 130 transmits the instruction rewriting order Sc.

The host, in response to the reception of the instruction rewriting order Sc, transfers the next instruction sequence 4 to the second E-memory 116 to be stored therein as in the foregoing manner.

The operations 3 and 4 are subsequently repeated while renewing the instruction sequences.

As described, according to the present embodiment, the host previously traces the instructions according to the execution sequence, memorizes the leading addresses and transfer byte numbers of the instruction sequences, and transfers the instruction sequences prior to the unconditional branch and the instruction sequences from the unconditional branch destination instruction onwards to the respective independent E-memories to be stored therein. When the unconditional branch instruction is executed, the switchover of the E-memories is implemented. In this manner, the overhead resulting from the transfer traffic is controlled, thereby efficiently supplying the CPU with the instructions.

The present embodiment described the case of providing the two E-memories, however, when at lease three E-memories are provided, the frequency of the instruction transfer in executing the instructions can be reduced. Further, in the present embodiment, the communication between the system LSI and the host employed the serial method, however, other communications methods, such as the parallel method, can be employed.

Embodiment 3

In the embodiment 2, even when the branch destination of the unconditional branch instruction of the instruction sequence 1 fits into the same E-memory, the instructions from the branch destination onwards are written in the other E-memory as the instruction sequence 2. Because of that, the overhead resulting from the transfer traffic increases. An embodiment 3 of the present invention deals with the inconvenience. In the embodiment 3, FIGS. 1 and 4 are incorporated therein by reference.

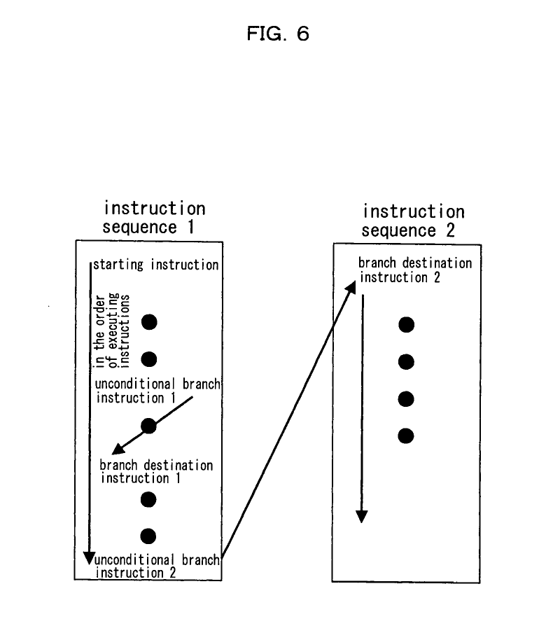

FIG. 6 shows instruction sequences including the unconditional branch instruction, the branch destination of which is present in the E-memory.

1. Operation of Writing Instruction in E-Memory

The host traces the instructions, from the starting instruction, according to the execution sequence to thereby judge whether or not the branch destination corresponds to the memory region of the first E-memory 115 in the presence of the unconditional branch instruction. When corresponding thereto, the host does not differentiate the instructions thereafter as the next instruction sequence but continuously handles them as the instruction sequence 1. When not corresponding thereto, the host memorizes the byte number up to that point as the transfer byte number of the instruction sequence 1. The leading address and transfer byte number of the instruction sequence 2 are memorized in the same manner.

The operation thereafter is the same as described earlier, that is, the instructions of the instruction sequence 1 equivalent to the memory capacity of the first E-memory 115 are written therein, and the instructions of the instruction sequence 2 equivalent to the memory capacity of the second E-memory 116 are written therein.

2. Operation when Branching by Unconditional Branch Instruction 1

The CPU outputs the instruction address of the instruction sequence 1. When the unconditional branch instruction 1 arrives, the currently-executed memory number “1” is the same as the memory number of the execution memory retaining portion 134, that is “1”. Therefore, the change detection portion 130 does not output the instruction rewriting order Sc.

When the unconditional branch instruction 2 arrives, the currently-executed memory number “2” is different to the memory number of the execution memory retaining portion 134, that is “1”. Therefore, the change detection portion 130 outputs the instruction rewriting order Sc.

As described, according to the present embodiment, when the instructions are previously traced according to the execution sequence in the host, it is judged whether or not the branch destination thereof falls under the memory capacity of the E-memory. When the judgment result is positive, the branch destination is not handled as a different instruction sequence. In this manner, the overhead resulting from the transfer traffic is controlled, thereby efficiently supplying the CPU with the instructions.

Embodiment 4

In the embodiment 2, the E-memory of the branch destination can be rewritten in its content in the presence of the unconditional branch instruction. However, in the case of branching from the instruction sequence 1 to the instruction sequence 2 by a subroutine call instruction, the branch to the instruction sequence 2 is first executed, and a recovery instruction from the subroutine is subsequently executed, and then, the instruction sequence 1 is executed again. In that case, it becomes necessary to write the instruction sequence 1 again in the E-memory, which leads the overhead caused by the transfer traffic to increase. An embodiment 4 of the present invention solves the foregoing problem. In the embodiment 4, FIG. 1 is incorporated therein by reference.

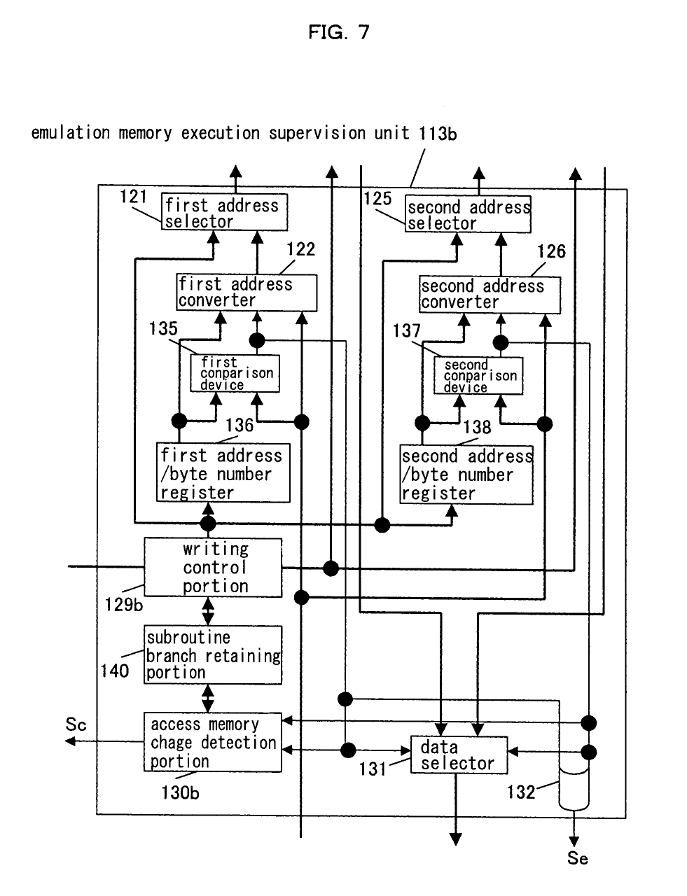

As shown in FIG. 7, the present embodiment is different to the embodiment 2 shown in FIG. 4 in that a subroutine branch retaining portion (hereinafter, abbreviated to retaining portion) 140 is provided therein. The retaining portion 140 retains a subroutine branch information written by a writing control portion 129b, and further retains the number of the branch changed in an access memory change detection portion (hereafter, abbreviated to change detection portion) 130b.

The host transfers, as well as the instructions, leading address, and transfer byte number of the instruction sequence, the subroutine branch information of the instruction sequence.

The writing control portion 129b writes the leading address and transfer byte number inputted from the transmission/reception unit in the first and second registers 136 and 138. The writing control portion 129b further writes the subroutine branch information in the retaining portion 140, and transmits the instructions to the first selector 121 or second selector 125.

The change detection portion 130b retains the judgment results of the first and second comparison devices 135 and 137, and checks the retaining portion 140 when the judgment results change to thereby subtract one from the subroutine branch information when the branch number of the subroutine branch information is one or above, and outputs the instruction rewriting order Sc to the transmission/reception unit when the branch number is zero.

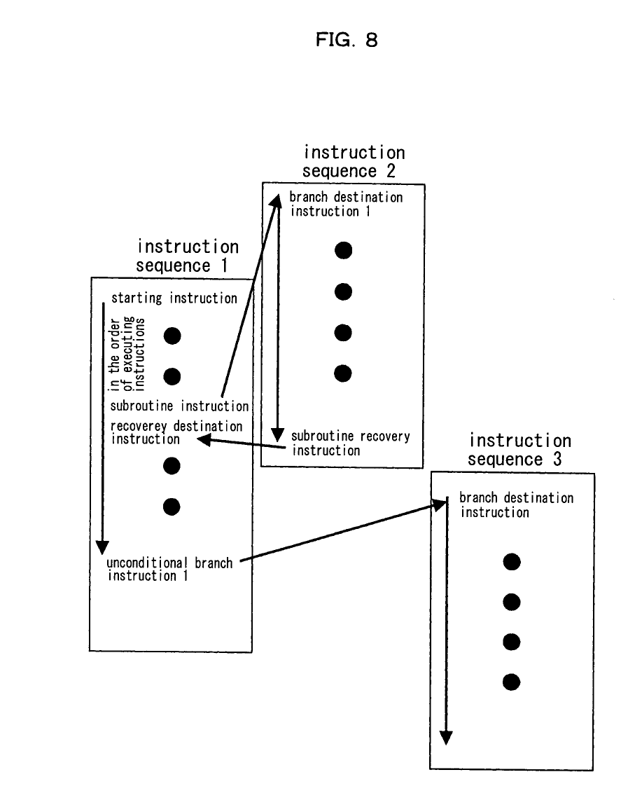

The operations of the debugger apparatus configured in the foregoing manner are described below. FIG. 8 shows instruction sequences transferred from the host.

1. Operation of Writing Instruction in E-Memory

The host traces the instructions, from the starting instruction, according to the execution sequence, andmemorizes, in the presence of the subroutine call instruction, the branch destination thereof as a subroutine instruction sequence and also the branch number thereof. When the unconditional branch instruction is reached, the host memorizes the byte number up to that point as the transfer byte number of the instruction sequence 1.

Next, the host traces the instructions according to the execution sequence from a branch destination instruction 1 executed by the CPU in the subroutine instruction sequence retained as described. When the subroutine recovery instruction is reached, the host memorizes the byte number up to that point as the transfer byte number of the instruction sequence 2. Further, the host memorizes the leading addresses, transfer byte numbers, the numbers of the subroutine call instructions regarding the instruction sequence 3 and instruction sequences thereafter.

The host transfers the instruction, leading address, and transfer byte number of the instruction sequence 1 to the writing control portion 129b via the transmission/reception unit. The writing control portion 129b writes the leading address and transfer byte number in the first register 136, and transmits the instruction sequence 1 to the first selector 121. The first E-memory 115 is accessed in reference to the address from the first selector 121, and writes the instructions of the instruction sequence 1 from the writing control portion 129b therein.

Next, the host transfers the instructions, leading address, transfer byte number, and subroutine branch information representing the branch number as one time of the instruction sequence 2 to the writing control portion 129b via the transmission/reception unit. The writing control portion 129b writes the leading address and transfer byte number in the second register 138, and writes the subroutine branch information representing the branch number as one time in the retaining portion 140. In this case, the second selector 125 sends out the address transmitted by the writing control portion 129b to the second E-memory 116. Based on the address, the second E-memory 116 is accessed, and the instructions of the instruction sequence 2 transmitted by the writing control portion 129b are thereby written.

The retaining portion 140 retains the information that the instruction sequence 2 corresponds to the subroutine from the subroutine branch information of the wiring control portion 129b.

2. Operation when Branching by Subroutine Call Instruction

When the subroutine call instruction arrives, the judgment result of the first comparison device 135 represents negative because the instruction address of the CPU does not fall within the transfer byte number from the leading address of the instruction sequence 1 of the first register 136. Therefore, the instruction address is not converted by the first converter 122.

In contrast to that, the judgment result of the second comparison device 137 represents positive because the instruction address of the CPU falls within the transfer byte number from the leading address of the instruction sequence 2 of the second register 138. The second converter 126, because of the positive judgment result of the second comparison device 137, converts the instruction address of the CPU into the address for accessing the second E-memory 116 based on the leading address and transfer byte number of the instruction sequence 2 of the second register 138. Thereafter, the CPU inputs the instructions read from the second E-memory 116 therein and executes them as in the described manner.

The change detection portion 130b checks the retaining portion 140 since the judgment results of the first and second comparison devices 135 and 137 change. Because the retained subroutine branch information shows the branch number as one time, not zero, the instruction rewriting order Sc is not outputted. As a result, the first E-memory 115 retains the instruction sequence 1. The change detection portion 130b subtracts one from the branch number of the retaining portion 140 to renew it to zero time.

3. Operation in Recovery by Subroutine Recovery Instruction

In the occurrence of the subroutine recovery, the judgment result of the second comparison device 137 represents negative since the instruction address of the CPU does not fall within the transfer byte number from the leading address of the instruction sequence 2 of the second register 138. Therefore, the address is not converted by the second converter 126.

Meanwhile, the judgment result of the first comparison device 135 represents positive since the instruction address of the CPU falls within the transfer byte number from the leading address of the instruction sequence 1 of the first register 136. Because of the positive judgment result of the first comparison device 135, the first converter 122 converts the instruction address of the CPU into the address for accessing the first E-memory 115 based on the leading address and transfer byte number of the instruction sequence 1 of the first register 136. Thereafter, the CPU inputs the instructions read from the first E-memory 115 therein and executes them in the same manner as described.

The change detection portion 130b checks the retaining portion 140 since the judgment results of the first and second comparison devices 135 and 137 change. The change detection portion 130b, because the retained subroutine branch information shows the branch number as zero time, outputs the instruction rewriting order Sc to the transmission/reception unit. The host, in receipt of the instruction rewriting order Sc, transfers the instructions, leading address and transfer byte number of the instruction sequence 3 to the writing control portion 129b via the transmission/reception unit. The writing control portion 129b writes the leading address and transfer byte number in the second register 138. In this case, the instructions of the instruction sequence 3 are written in the second E-memory 116 via the second selector 125.

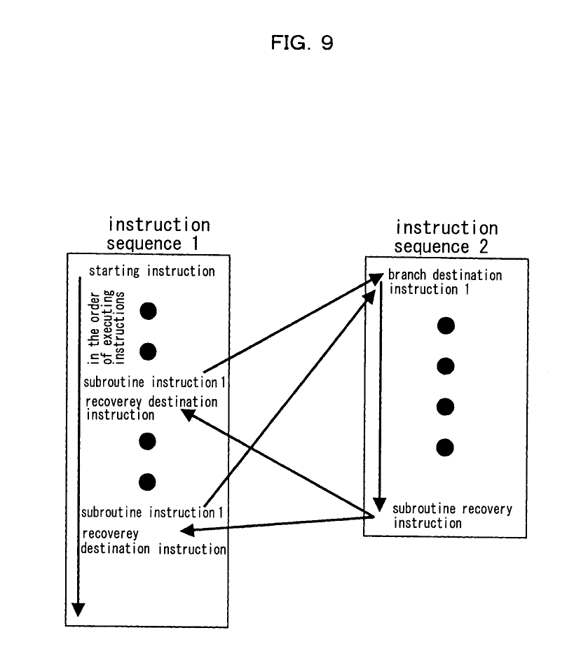

Next, the operations in the subroutine branch to the same instruction sequence 2 two times, as shown in FIG. 9, are described below.

1. Operation of Writing Instruction in E-Memory

In FIG. 8, the branch number of the instruction sequence 2 is one time, whereas the branch number in FIG. 9 is two times. Therefore, the branch number of two times as the subroutine information is written in the retaining portion 140. The rest of the operation is the same as described in the operation 1. referring to FIG. 8.

2. Operation when Branching by Subroutine Call Instruction

When the subroutine call instruction arrives, the change detection portion 130b checks the retaining portion 140, and does not output the instruction rewriting order Sc because the retained branch number shows two times. As a result, the first E-memory 115 retains the instruction sequence 1. The change detection portion 130b subtracts one from the branch number of the retaining portion 140 to renew it to one time.

3. Operation in Recovery by Subroutine Recovery Instruction

In the occurrence of the subroutine recovery, the change detection portion 130b checks the retaining portion 140, and does not output the instruction rewriting order Sc because the retained branch number represents one time. The first E-memory 115 retains the instruction sequence 1. The change detection portion 130b subtracts one from the branch number of the retaining portion 140 to renew it to zero time.

At the time of the subroutine branch for the second time, the instruction rewriting order Sc is outputted because the branch number of the retaining portion is zero, and the data of the next instruction sequence is transferred from the host.

As described, according to the present embodiment, in the case of branching by the subroutine call instruction, the subroutine branch information and branch number thereof are retained. When the branch is executed by the subroutine call instruction, the instruction sequence in the branch origin is not changed. In such a manner, the overhead caused by the transfer traffic in the rewriting processing is controlled so that the CPU can be efficiently supplied with the instructions.

The present embodiment described the case of providing the two E-memories. When at lease three E-memories are provided, the frequency of the instruction transfer in executing the instructions can be reduced. Further, in the present embodiment, the communication between the system LSI and host employed the serial method, however, other communications methods, such as the parallel method, can be employed.

Further, it is possible for the instruction sequences to be handled as the same instruction sequence by means of the host described in the embodiment 3 in the case in which the subroutine branch destination instruction corresponds to the memory capacity of the E-memory.

Embodiment 5

In the embodiments 1 through 4, when an exception processing such an interruption is implemented during the time when the instruction sequence 1 is executed, the instruction sequence 1 is executed again after the recovery from the exception processing, which makes it necessary to write the instruction sequence 1 again in the E-memory. As a result, the overhead caused by the transfer traffic is increased. An embodiment 5 of the present invention is designed to respond to the inconvenience. In the embodiment 5, FIG. 1 is incorporated therein by reference.

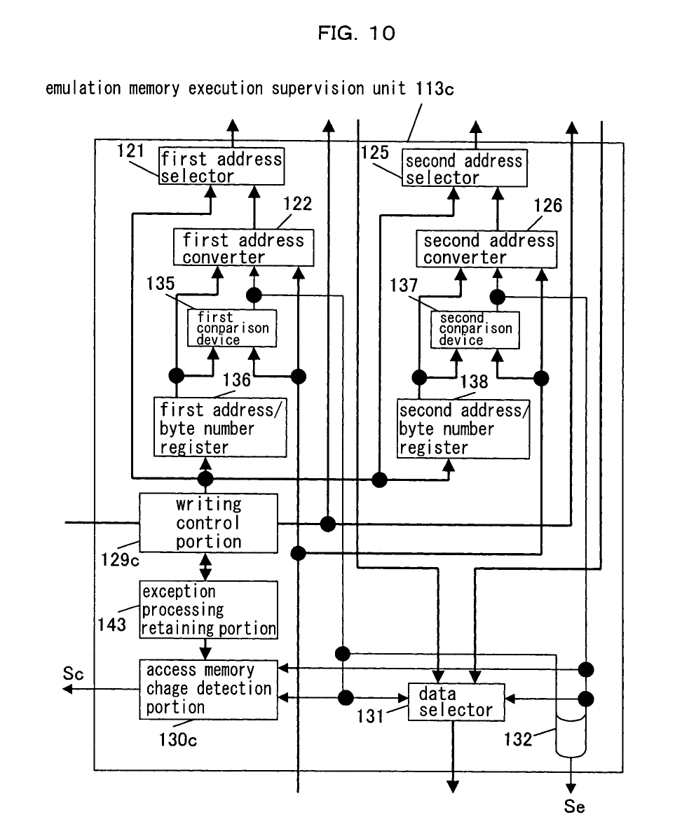

As shown in FIG. 10, the present embodiment is different to the embodiment 2 shown in FIG. 4 in that an exception processing retaining portion (hereinafter, abbreviated to retaining portion) 143 is provided therein. The retaining portion 143 retains an exception processing information written by a writing control portion 129c, and outputs the retained information to a change detection portion 130c.

The host transfers the exception processing information of the instruction sequence as well as the instructions, leading address and transfer byte number thereof.

The writing control portion 129c writes the leading address and transfer byte number inputted from the transmission/reception unit in the first register 136 or second register 138, and further writes the exception processing information in the retaining portion 143. The writing control portion 129c sends out the instructions to the first selector 121 or second selector 125.

The change detection portion 130c retains the judgment results of the first and second comparison devices 135 and 137, and checks the retaining portion 143 when the judgment results change. The change detection portion 130c outputs the instruction rewriting order Sc to the transmission/reception unit when there is no exception processing.

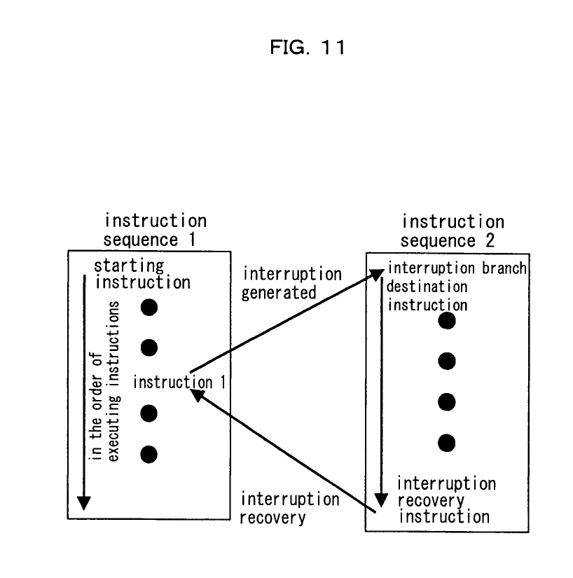

The operations of the debugger apparatus configured in the foregoing manner are described below. FIG. 11 shows instruction sequences transferred from the host.

1. Operation of Writing Instruction in E-Memory

The host traces the instructions according to the execution sequence, from the starting instruction to be executed in an interruption branch destination up to an interruption recovery instruction, and memorizes the leading address of the instruction sequence 2. The host further handles the byte number of the instruction sequence as the transfer byte number of the instruction sequence 2, and memorizes the exception processing information.

Next, the host traces the instructions, from the starting instruction, according to the execution sequence, and memorizes, in the presence of the unconditional branch instruction, the byte number up to that point as the transfer byte number of the instruction sequence 1.

The host transfers the instructions, leading address, and transfer byte number of the instruction sequence 1 to the writing control portion 129c via the transmission/reception unit. The writing control portion 129c writes the leading address and transfer byte number in the first register 136. The first E-memory 115 is accessed in accordance with the address from the first selector 121 and writes the instructions of the instruction sequence 1 therein.

Next, the host transfers the instructions, leading address, transfer byte number, and exception processing information of the instruction sequence 2 to the writing control portion 129c via the transmission/reception unit. The writing control portion 129c writes the leading address and transfer byte number in the second register 138, and further writes the exception processing information in the retaining portion 143. The writing control portion 129c transmits the instructions of the instruction sequence 2 to the second E-memory 116 via the second selector 125. The retaining portion 143 retains the exception processing information of the instruction sequence 2 written by the writing control portion 129c. The second E-memory 116 inputs the address from the second selector 125 and writes the instructions of the instruction sequence 2 therein.

2. Operation when Interruption is Generated

The CPU accepts the interruption, and outputs the instruction address for the purpose of branching by an interruption branch destination instruction. In compliance with the change of the instruction address, the judgment result of the first comparison device 135 represents negative, while the judgment result of the second comparison device 137 represents positive. In consequence of that, the first converter 122 becomes nonoperational, and the second converter 126 converts the instruction address of the CPU into the address for accessing the second E-memory 116. Thereafter, the CPU inputs the instructions read from the second E-memory 116 therein and executes them in the manner same as described.

The change detection portion 130c checks the retaining portion 143, and because the exception processing information of the instruction sequence 2 is stored therein, does not output the instruction rewriting order Sc. As a result, the first E-memory 115 retains the instruction sequence 1.

3. Operation in Recovery by Interruption Recovery Instruction

The CPU outputs the instruction address of an interruption generation instruction by the interruption recovery instruction. In response to the change of the instruction address, the judgment result of the second comparison device 137 shows negative, whereas the judgment result of the first comparison device 135 shows positive. As a result, the second converter 126 becomes nonoperational, and the first converter 122 converts the instruction address of the CPU into the address for accessing the first E-memory 115. Thereafter, the CPU inputs the instructions read from the first E-memory 115 therein and executes them in the same manner as described earlier.

The change detection portion 130c checks the retaining portion 140, and because the exception processing information is not stored therein, outputs the instruction rewriting order Sc to the transmission/reception unit. The host, in receipt of the instruction rewriting order Sc, transfers the data of the next instruction sequence.

As described, according to the present embodiment, when the exception processing such as the interruption is generated, the information of the exception processing is retained. In the case of branching by the exception processing, the instruction sequence in the branch origin is controlled not to change. In this manner, the overhead caused by the transfer traffic in the rewriting processing is controlled to thereby efficiently supply the CPU with the instructions.

In the present embodiment, one of the E-memories is exclusively used for the exception processing, which allows only one E-memory to be used for any normal processing. As a result, the overhead is generated by the branch. In order to solve the problem, providing at lease three E-memories can avoid the generation of the overhead.

Further, in the present embodiment, the communication between the system LSI and the host employed the serial method, however, other communications methods, such as the parallel method, can be employed.

Embodiment 6

In the embodiments 1 through 5, when the instruction sequence includes a conditional branch instruction, the processing executed varies depending on the establishment or failure of the conditional branch instruction. The instruction sequence of the instruction destination is already written in the E-memory on the assumption that the conditional branch instruction is established. Therefore, it is unnecessary to write the instruction sequence of the branch destination in the E-memory when established. When not established, it becomes naturally necessary to rewrite it with a different instruction sequence, during the process of which the overhead resulting from the transfer traffic is increased. An embodiment 6 of the present invention is presented to deal with the inconvenience. In the present embodiment, FIG. 1 is incorporated therein by reference.

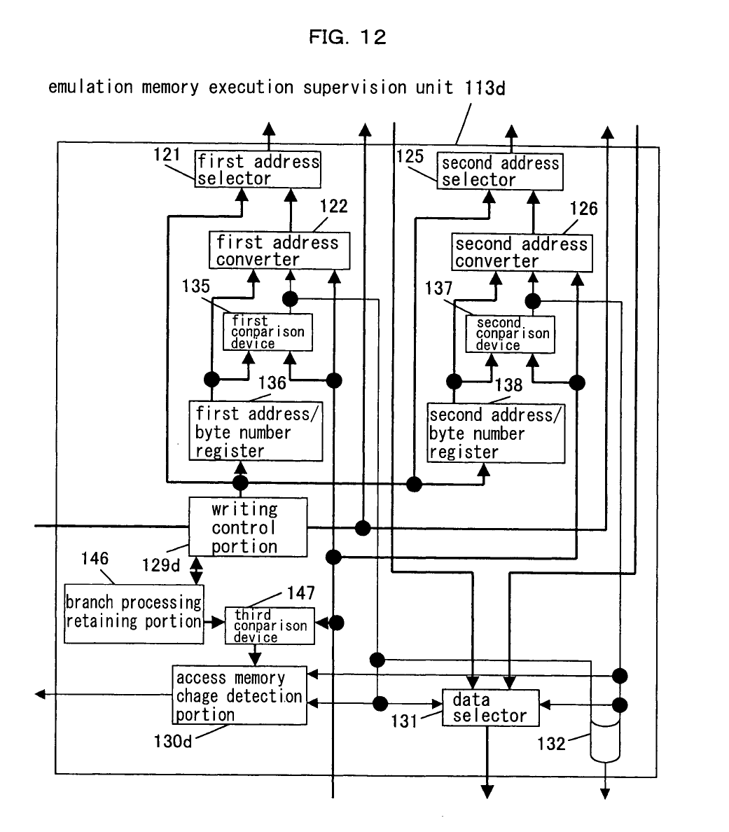

As shown in FIG. 12, the present embodiment is different to the embodiment 2 shown in FIG. 4 in that a branch processing retaining portion (hereinafter, abbreviated to retaining portion) 146 and a third comparison device 147 are provided therein. The retaining portion 146 retains an address of the conditional branch instruction written by a writing control portion 129d, and outputs the address of the conditional branch instruction to the third comparison device 147. The third comparison device 147 compares the address of the conditional branch instruction of the retaining portion 146 to the instruction address of the CPU, and outputs a branch instruction execution information to a change detection portion 130d when the addresses are identical to each other.

The host transfers the address of the conditional branch instruction of the instruction sequence as well as the instructions, leading address, and transfer byte number thereof.

The writing control portion 129d writes the leading address and transfer byte number inputted from the transmission/reception unit in the first register 136 or second register 138, and further writes the address of the conditional branch instruction in the retaining portion 146. The writing control portion 129d then transmits the instructions to the first selector 121 or second selector 125.

The change detection portion 130d inputs the branch instruction execution information of the third comparison device 147 therein, and when the branch is established in the next cycle of executing the instruction, sets the instruction rewriting order Sc to be in a first state that the instruction sequence in the branch origin is rewritten, and outputs it to the transmission/reception unit. When the branch is not established in the next execution cycle, the change detection portion 130d sets the instruction rewriting order Sc to be in a second state that the instruction sequence in the branch destination is rewritten, and outputs it to the transmission/reception unit.

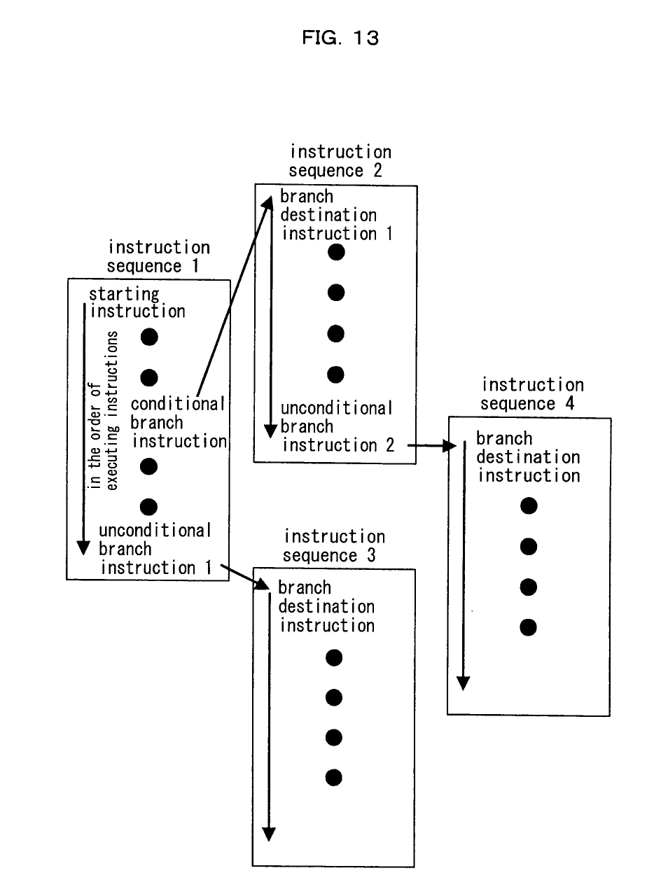

The operations of the debugger apparatus configured in the foregoing manner are described below. FIG. 13 shows instruction sequences transferred from the host.

1. Operation of Writing Instruction in E-Memory

The host traces the instructions, from the starting instruction, according to the execution sequence, and executes the same processing as the previously described. The host further memorizes the address of the conditional branch instruction and retains the branch destination as a conditional-branch-established instruction sequence in the presence of the conditional branch instruction.

Next, the host traces the instructions in the conditional-branch-established instruction sequence retained as described sequence according to the execution sequence, and memorizes the leading address of the instruction sequence 2. The host regards the byte number of the instruction sequence as the transfer byte number of the instruction sequence 2, and further memorizes a conditional-branch-established instruction information. The host further memorizes the leading address and transfer byte number of the instruction sequence 3 and the instruction sequences thereafter.

The host transfers the instruction, address of the conditional branch instruction, transfer byte number of a leading address column 1 of the instruction sequence 1 to the writing control portion 129d via the transmission/reception unit. The writing control portion 129d writes the leading address and transfer byte number in the first register 136, and writes the address of the conditional branch instruction in the retaining portion 146. The First E-memory 115 is accessed in accordance with the address from the first selector 121, and writes the instructions of the instruction sequence 1 from the writing control portion 129d therein. The retaining portion 146 retains the address of the conditional branch instruction written by the writing control portion 129d.

Next, the host executes the same processing to the instruction sequence 2 in the same manner, and writes the instructions of the instruction sequence 2 in the second E-memory 116.

2. Operation when Branch Instruction of Instruction Sequence 1 is Established

The CPU executes the instruction sequence and conditional branch instruction 1 thereof. The third comparison device 147 compares the address of the conditional branch instruction of the retaining portion 146 to the instruction address of the CPU. The third comparison device 147, because the two addresses are identical to each other here, outputs the branch instruction execution information to the change detection portion 130d.

In the next cycle of executing the instruction, the conditional branch instruction of the instruction sequence 1 is established. Therefore, the CPU outputs the instruction address of the branch destination instruction 1 of the instruction sequence 2. In compliance with the change of the instruction address, the first comparison device 135 shows the judgment result as negative, while the second comparison device 137 shows the judgment result as positive. As a result, the first converter 122 becomes nonoperational, the second converter 126 converts the instruction address of the CPU into the address for accessing the second E-memory 116. Thereafter, the CPU, as in the described manner, inputs the instructions read from the second E-memory 116 therein and execute them.

The change detection portion 130d judges that the branch is established from the judgment results of the first and second comparison devices 135 and 137, and sets the instruction rewriting order Sc to be in the first state that the instruction sequence 1 in the branch origin is rewritten into the instruction sequence 4, and outputs it to the transmission/reception unit. In consequence of that, the instruction sequence 4 is written in the first E-memory 115.

3. Operation when Conditional Branch Instruction of Instruction Sequence 1 is not Established

The CPU executes the instruction sequence 1 and conditional branch instruction thereof. The third comparison device 147 compares the address of the conditional branch instruction of the retaining portion 146 to the instruction address of the CPU. The third comparison device 147, because the two addresses are identical to each other here, outputs the branch instruction execution information to the change detection portion 130d.

In the next execution cycle, the conditional branch instruction of the instruction sequence 1 is not established. Therefore, the CPU outputs the instruction address of the instruction subsequent to the conditional branch instruction in the instruction sequence 1. In compliance with the change of the address, the first comparison device 135 shows the judgment result as positive, while the second comparison device 137 shows the judgment result as negative. The change detection portion 130d judges that the branch is not established from the judgment results of the first and second comparison devices 135 and 137, and sets the instruction rewriting order Sc to be in the second state that the instruction sequence 2 in the conditional branch destination is rewritten into the instruction sequence 3, and outputs it to the transmission/reception unit. As a result, the instruction sequence 3 is written in the first E-memory 115.

As described, when the instruction sequence includes the conditional branch instruction, the branch destination instruction sequence becomes necessary or unnecessary depending on the establishment or failure of the conditional branch instruction. Therefore, only the unnecessary instruction sequence is rewritten into the next necessary instruction sequence so that the overhead resulting from the transfer traffic in the rewriting processing is controlled, thereby efficiently supplying the CPU with the instructions.

Further, it is possible to handle the instruction sequences as an identical instruction sequence by means of the host described in the embodiment 3 when the conditional branch destination instruction corresponds to the memory capacity of the E-memory.

Embodiment 7

In the case of the embodiment 6, when a plurality of conditional branches are included in the instruction sequence, the transfer traffic from the host with respect to the instruction sequence to be subsequently executed becomes busy. This results in the increase of the overhead caused by the transfer traffic when rewriting the instruction sequence. An embodiment 7 of the present invention responds to the inconvenience. In the embodiment 7, FIG. 1 is incorporated therein by reference.

As shown in FIG. 4, the present embodiment is different to the embodiment 6 shown in FIG. 12 in that a branch processing retainer FIFO 151 is provided therein. The FIFO 151 retains the addresses of the plurality of conditional branch instructions written by a writing control portion 129e according to the writing sequence, and outputs the address of the conditional branch instruction in a front stage to a third comparison device 147e. Further, the FIFO 151 shifts the retained addresses of the conditional branch instructions to a preceding stage one by one when a judgment result of the third comparison device 147e shows identical. The third comparison device 147e compares the addresses of the conditional branch instructions of the FIFO 151 to the instruction address of the CPU, and outputs the branch instruction execution information to the change detection portion 130e and FIFO 151 when they are identical to each other.

The writing control portion 129e inputs therein the instructions, leading address, transfer byte number, and addresses of the plurality of conditional branch instructions in the instruction sequence from the transmission/reception unit, and writes the leading address and transfer byte number in the first register 136 or second register 138, and writes the addresses of the plurality of conditional branch instructions in the FIFO 151. The writing control portion 129 then transmits the instruction to the first selector 121 or second selector 125.

The change detection portion 130e inputs the branch instruction execution information of the third comparison device 147e therein, and sets the instruction rewriting order Sc to be in the first state that the instruction sequence in the branch origin is rewritten and outputs it to the transmission/reception unit when the branch is established in the next execution cycle. The change detection portion 130e further resets any value stored in the FIFO 151, and when the branch is not established in next execution cycle, sets the instruction rewriting order Sc to be in the second state that the instruction sequence in the branch destination is rewritten and outputs it to the transmission/reception unit.

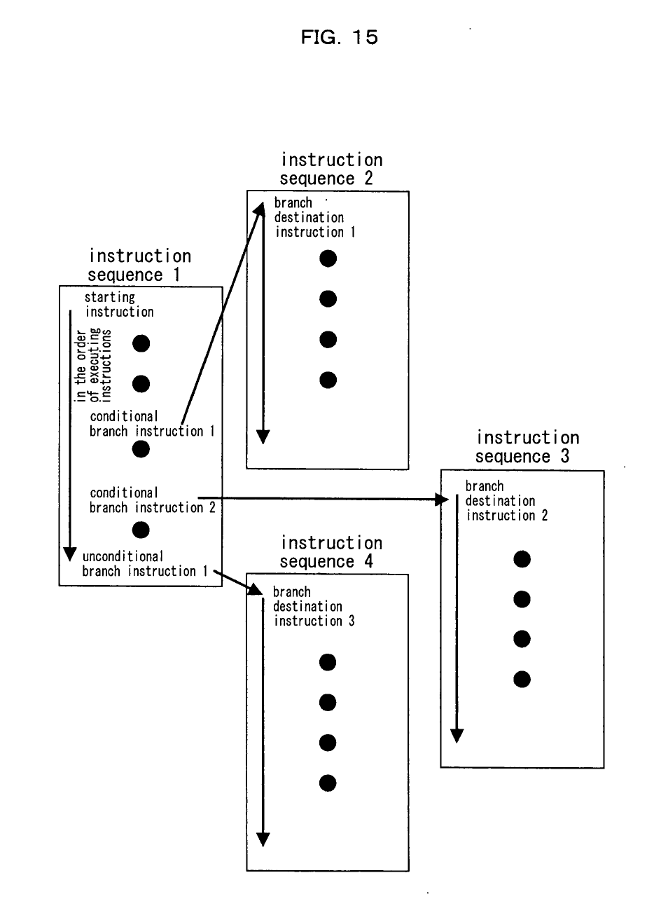

The operations of the debugger apparatus configured in the foregoing manner are described below. FIG. 15 shows instruction sequences transferred from the host.

1. Operation of Writing Instruction in E-Memory

The host traces the instructions, from the starting instruction, according to the execution sequence. The host, in the presence of the two conditional branch instructions, memorizes the respective addresses thereof and retains the respective branch destinations thereof as the conditional-branch-established instruction sequences. The host, other than the foregoing, executes the processing same as the described before.

Next, the host traces the instructions, following the order of execution, from the branch destination instruction 1 and branch destination instruction 2, which are executed by the CPU in the two retained conditional-branch-established instruction sequences. The host memorizes the leading addresses of the instruction sequences 2 and 3, and further memorizes the transfer byte numbers of the instruction sequences 2 and 3, and the respective conditional-branch-established instruction information thereof. The host further memorizes the leading addresses and transfer byte numbers of the instruction sequence 4 and instruction sequences thereafter.

The host transfers the instructions, the transfer byte number and branch instruction address of the conditional branch instruction 1, and the transfer byte number and branch instruction address of the conditional branch instruction 2 in the instruction sequence 1 to the writing control portion 129e via the transmission/reception unit. The writing control portion 129e writes the leading address and transfer byte numbers in the first register 136. The writing control portion 129e writes the branch instruction address of the conditional branch instruction 1 and the branch instruction address of the conditional branch instruction 2 in the FIFO 151 in sequence.

As in the same manner, the instructions of the instruction sequence 1 are written in the first E-memory 115, and the instructions of the instruction sequence 2 are written in the second E-memory 116.

2. Operation when Conditional Branch Instruction 1 of Instruction Sequence 1 is Executed and Branch is Accordingly Established

The CPU executes the instruction sequence 1 and conditional branch instruction 1 thereof. The third comparison device 147e compares the branch instruction address of the conditional branch instruction 1 of the FIFO 151 to the instruction address of the CPU. The CPU, because the two addresses are identical to each other here, outputs the branch instruction execution information to the change detection portion 130e.

In the next execution cycle, the CPU, because the conditional branch instruction of the conditional branch instruction 1 of the instruction sequence 1 is established, subsequently outputs the instruction address of the branch destination instruction 1 of the instruction sequence 2. In compliance with the change of the instruction address, the judgment result of the first comparison device 135 represents negative, while the judgment result of the second comparison device 137 represents positive. As a result, the first converter 122 becomes nonoperational, and the second converter 126 converts the instruction address of the CPU into the address for accessing the second E-memory 116. The CPU, in the foregoing manner, inputs the instructions read from the second E-memory 116 therein and executes them.

The change detection portion 130e judges that the branch is established from the judgment results of the first and second comparison devices 135 and 137, and sets the instruction rewriting order Sc to be in the first state that the instruction sequence 1 of the branch origin is rewritten into the instruction sequence subsequent to the instruction sequence 2 (not shown) and outputs it to the transmission/reception unit. The change detection portion 130e, because the branch is established, resets any value stored in the FIFO 151.

3. Operation when Conditional Branch Instruction 1 of Instruction Sequence 1 is Executed Resulting in Failure to Branch, and Conditional Branch Instruction 2 Thereof is Executed Resulting in Establishment of Branch

The CPU executes the instruction sequence 1 and conditional branch instruction 1 thereof. The third comparison device 147e compares the branch instruction address of the conditional branch instruction 1 of the FIFO 151 to the instruction address of the CPU. The third comparison device 147e, because they are identical to each other here, outputs the branch instruction execution information to the change detection portion 130e.

In the next execution cycle, the CPU, because the conditional branch instruction of the conditional branch instruction 1 of the instruction sequence 1 is not established, outputs the instruction address of the next instruction from the conditional branch instruction 1. The judgment result of the first comparison device 135 remains positive, while the judgment result of the second comparison device 137 represents negative. The change detection portion 130e judges that the branch is not established from the judgment results of the first and second comparison devices 135 and 137, and sets the instruction rewriting order Sc to be in the second state that the instruction sequence 2 in the conditional branch destination is rewritten into the instruction sequence 3 and outputs it to the transmission/reception unit. The FIFO 151 shifts the addresses of the conditional branch instructions, which are retained when the judgment result of the third comparison device 147e shows identical, to the preceding stage one by one. The address in the front stage is changed to the address of the conditional branch instruction 2. The CPU executes the instruction sequence 1 and conditional branch instruction 2 thereof. The third comparison device 147e compares the branch instruction address of the conditional branch instruction 2 of the FIFO 151 to the instruction address of the CPU. The third comparison device 147e, because the two addresses are identical to each other here, outputs the branch instruction execution information to the change detection portion 130e.

In the next execution cycle, the CPU, because the conditional branch instruction of the conditional branch instruction 2 of the instruction sequence 1 is established, outputs the instruction address of the branch destination instruction 1 of the instruction sequence 2. In compliance with the change of the instruction address, the judgment result of the first comparison device 135 represents negative, while the judgment result of the second comparison device 137 represents positive. As a result, the first converter 122 becomes nonoperational, and the second converter 126 converts the instruction address of the CPU into the address for accessing the second E-memory 116.

The change detection portion 130e judges that the branch is established from the judgment results of the first and second comparison devices 135 and 137, and sets the instruction rewriting order Sc to be in the first state that the instruction sequence 1 of the branch origin is rewritten into the instruction sequence to be executed subsequent to the instruction sequence 3, and outputs it to the transmission/reception unit. The change detection 130e further resets any value stored in the FIFO 151 because the branch is established. As a result, the instruction sequence 3 is written in the second E-memory 116.

4. Operation when Conditional Branch Instruction 1 of Instruction Sequence 1 is Executed Resulting in Failure to Branch, and Conditional Branch Instruction 2 Thereof is Executed Resulting in Establishment of Branch

The operation when the conditional branch instruction 1 of the instruction sequence 1 is executed resulting in the failure tobranch is the same as in the description of 3. Further, because the conditional branch instruction of the conditional branch instruction 2 of the instruction sequence 1 is not established, the instruction address of the next instruction from the conditional branch instruction 2 is outputted. The judgment result of the first comparison device 135 is positive, while the judgment result of the second comparison device 137 is negative. The change detection portion 130e judges that the branch is not established from the judgment results of the first and second comparison devices 135 and 137, and sets the instruction rewriting order Sc to be in the second state that the instruction sequence 3 in the conditional branch destination is rewritten into the instruction sequence 4 and outputs it to the transmission/reception unit. The FIFO 151 shifts the addresses of the conditional branch instructions, which are retained when the judgment result of the third comparison device 147e shows identical, to the preceding stage one by one, and the address of the conditional branch instruction retained in the front stage is cleared. In consequence of that, the instruction sequence 4 is written in the second E-memory 116.

As described, when the instruction sequence includes the plurality of conditional branches, the addresses of the plurality of conditional branch instructions are retained in the FIFO, the shifting is implemented every time when the branch is not established, and the content of the FIFO is cleared when the branch is established. This controls the overhead caused by the transfer traffic when rewriting the instruction sequence to deal with the establishment/failure of the plurality of conditional branches so that the instructions are efficiently supplied to the CPU.

It is possible for the instruction sequences to be handled as an identical instruction sequence by means of the host described in the embodiment 3 in the case in which the conditional branch destination instruction corresponds to the memory capacity of the E-memory

Embodiment 8

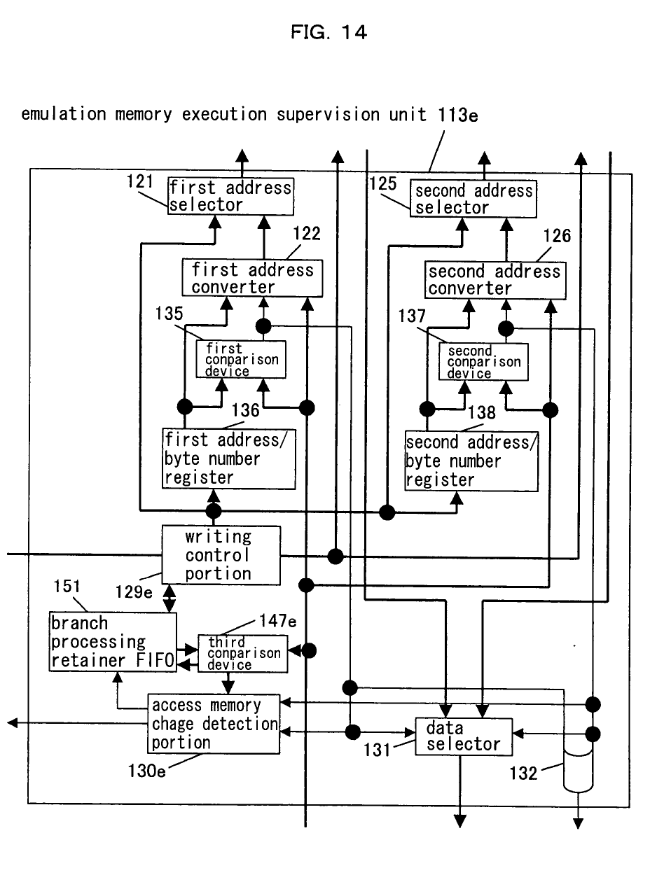

In the embodiments 6 and 7, the instruction sequence in the branch destination or instruction sequence subsequent to the conditional branch instruction possibly becomes unnecessary depending on the establishment or failure of the conditional branch instruction. In such a case, the overhead resulting from the transfer traffic when rewriting the instructions is increased. An embodiment 8 of the present invention responds to the problem. In the embodiment 8, FIGS. 1 and 14 are incorporated therein by reference.

The host is a computer comprised of a debugger apparatus having a function of constantly forecasting a value of a register 0 of the CPU by previously implementing a simulation to the instruction sequences executed by the CPU.

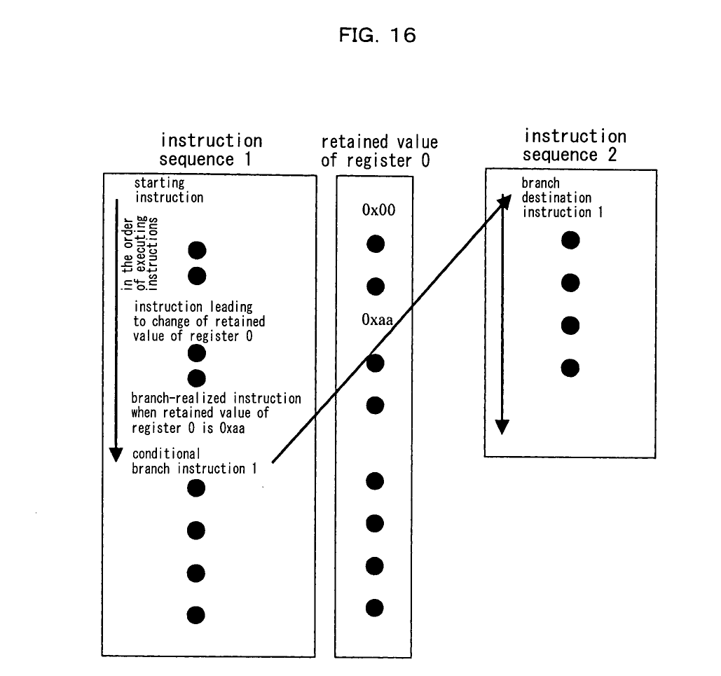

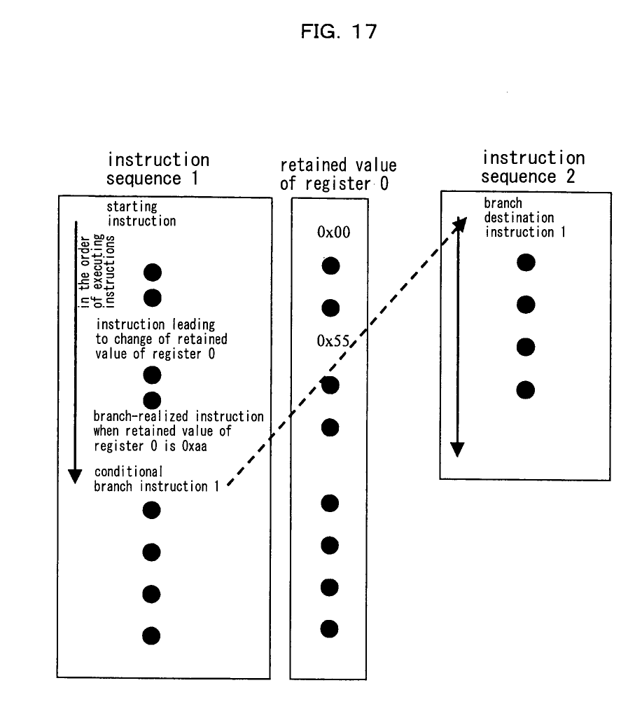

The operations of the debugger apparatus configured in the foregoing manner are described below. As shown in FIGS. 16 and 17, the simulation is previously implemented to the instruction sequence executed by the CPU in the host to thereby constantly forecast the value of the register 0, which is transferred from the host after the simulation is completed.

1. Operation of Writing Instruction when Host Simulates Instruction Executed by CPU, and Branch by Conditional Branch Instruction 1 is Established

The host, when tracing the instructions, previously implements the simulation, as well as the processing as described, to the instruction sequence executed by the CPU. By doing so, the value of the register 0 at the time of executing the instructions of the instruction sequence 1 is forecasted, as shown in FIG. 16. At that time, it is forecasted that the branch of the conditional branch instruction 1 is established.

The execution supervision unit writes the instructions of the instruction sequence 1 in the first E-memory 115, and writes the instructions of the instruction sequence 2 in the second E-memory 116.

2. Operation of Writing Instruction when Host Simulates Instruction Executed by CPU, and Branch by Conditional Branch Instruction 1 is Not Established

The host, when tracing the instructions, previously implements the simulation, as well as the processing as described, to the instruction sequence executed by the CPU. By doing so, the value of the register 0 at the time of executing the instructions of the instruction sequence 1 is forecasted, as shown in FIG. 16. At that time, it is forecasted that the branch of the conditional branch instruction 1 is not established.

3. Operation of Conditional Branch Instruction 1 wherein CPU Executes Instruction Written in Operation 1.

The CPU executes the instruction sequence 1 and conditional branch instruction 1 thereof. The third comparison device 147e compares the branch instruction address of the conditional branch instruction 1 of the FIFO 151 to the instruction address of the CPU. The CPU, since the two addresses are equal to each other here, outputs the branch instruction execution information to the change detection portion 130e.

In the next execution cycle, the CPU, after the conditional branch instruction of the conditional branch instruction 1 of the instruction sequence 1 is established, outputs the instruction address of the branch destination instruction 1 of the instruction sequence 2. The first comparison device 135 shows the judgment result as negative, while the second comparison device 137 shows the judgment result as positive. The second converter 126 converts the instruction address of the CPU into the address for accessing the second E-memory 116. Thereafter, the CPU inputs the instructions read from the second E-memory 116 and executes them in the same manner as described.

The change detection portion 130e judges that the branch is established from the judgment results of the first comparison devices 135 and 137, and sets the instruction rewriting order Sc to be in the first state that the instruction sequence 1 of the branch origin is rewritten into the instruction sequence subsequent to the instruction sequence 2 (not shown) and outputs it to the transmission/reception unit. The change detection portion 13e further, since the branch is established, resets any value stored in the FIFO 151.

4. Operation of Conditional Branch Instruction 1 wherein CPU Executes Instruction Written in Operation 2.

The CPU executes the instruction sequence 1 and conditional branch instruction 1 thereof. The FIFO 151 does not retain the branch instruction address of the conditional branch instruction 1. The judgment result of the first comparison device 135 is positive, while the judgment result of the second comparison device 137 is negative. The first converter 122 converts the instruction address of the CPU into the address for accessing the firstE-memory 115. Thereafter, the CPU, in the foregoing manner, inputs the instructions read from the first E-memory 115 therein and executes them.

The change detection portion 130e does not recognize the conditional branch instruction 1 as the branch instruction, therefore does not output the instruction rewriting order Sc.

As described, according to the present embodiment, when the instructions to be executed are previously traced in the host, the simulation of the instruction sequence is implemented so that the value of the internal register is checked to thereby forecast whether or not the branch is established. Doing so controls the overhead caused by the transfer traffic when rewriting the instruction sequence to deal with the establishment/failure the conditional branch, resulting in the efficient supply of the instructions to the CPU.

Embodiment 9

In the embodiments 1 through 8, the contents of the E-memories are rewritten based on the analysis of the behavior of the respective instructions from the program. Under such circumstances, even if the E-memories are provided with an enough capacity to store one or more tasks of the OS, the overhead resulting from the transfer traffic in rewriting is still increased. An embodiment 9 of the present invention is presented to solve the problem. In the embodiment 9, FIG. 1 is incorporated therein by reference.

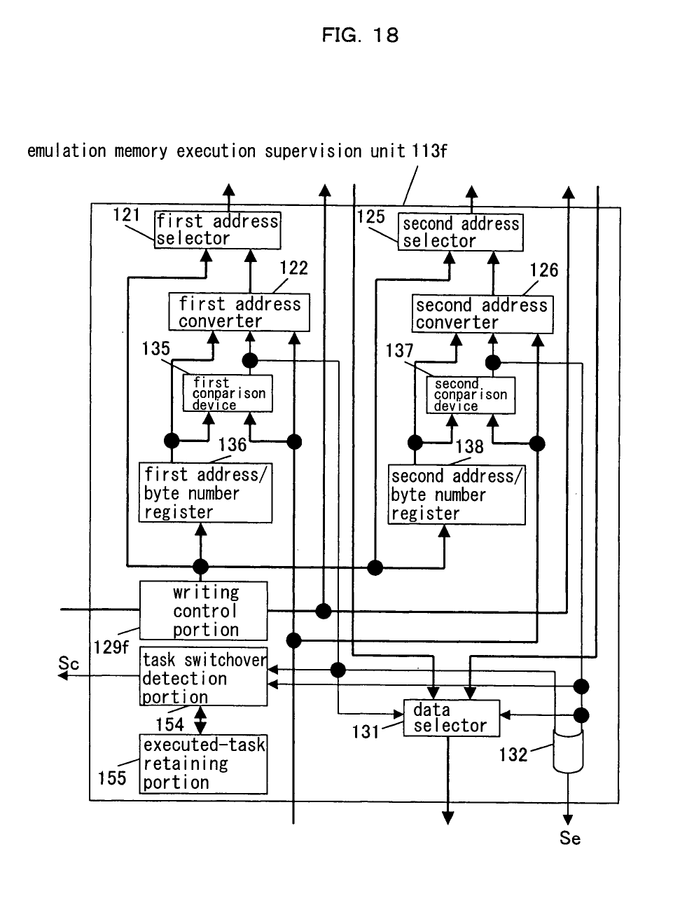

As shown in FIG. 18, an E-memory execution supervision unit 113f comprises a task switchover detection portion 154 and an executed-task retaining portion 155.

The task switchover detection portion 154 writes a currently-executed task number in the executed-task retaining portion (hereinafter, abbreviated to retaining portion) 155 from the judgment results of the first and second comparison devices 135 and 137. The task switchover detection portion 154 outputs the instruction rewriting order Sc to the transmission/reception unit when the currently-executed task number and the task number of the retained portion 155 are different to each other from the judgment results of the first and second comparison devices 135 and 137. The retaining potion 155 retains a task number 1 as an initial value, and retains the currently-executed task number written by the task switchover detection portion 154 to thereby output the retained task number to the task switchover detection portion 154.

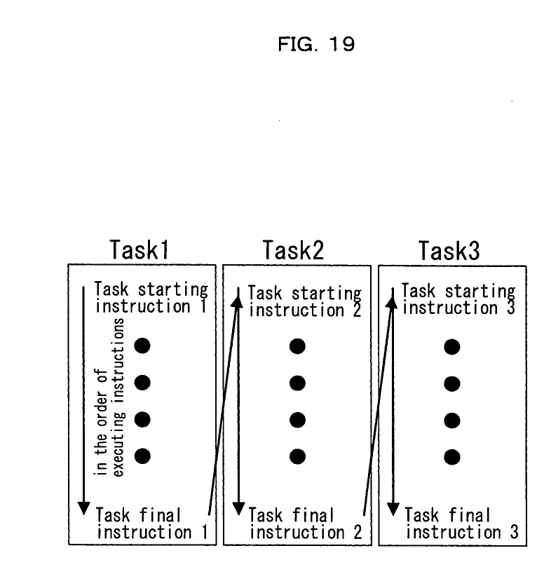

The operations of the debugger apparatus configured in the foregoing manner are described below. FIG. 19 shows tasks transferred from the host.

1. Operation of Writing Instruction in E-Memory

The host divides the program per task of the OS, and traces the instructions according to the execution sequence from the starting instruction first to final instruction in the task executed by the CPU. The host memorizes a first address as a leading address of the task 1, and also memorizes a byte number of the traced task as a byte number of the task 1. Next, the host handles a task 2 in the same manner as in the task 1, and memorizes a leading address and transfer byte number thereof. The same processing is implemented to any other task.

The host transfers the instructions, leading address, and transfer byte number of the task 1 to a writing control portion 129f via the transmission/reception unit. The writing control portion 129f writes the leading address and transfer byte number in the first register 136, and transmits the instructions of the task 1 to the first selector 121. The first E-memory 115 inputs the address from the first selector 121 therein, and thereby writes the instructions of the task 1 therein.

The host transfers the instructions, leading address, and transfer byte number of the instruction of the task 2 to the writing control portion 129f via the transmission/reception unit. The writing control portion 129f writes the leading address and transfer byte number in the second register 138, and transmits the instructions of the task 2 to the second selector 125. The second E-memory 116 inputs the address from the second selector 125 therein, and thereby writes the instructions of the task 2 therein.

2. Operation when CPU Executes Task 1

The CPU outputs the instruction address of the task 1. The judgment result of the first comparison device 135 shows positive, while the judgment result of the second comparison device 137 shows negative. The first converter 122, since the judgment result of the first comparison device 135 shows positive, converts the instruction address of the CPU into the address for accessing the first E-memory 115. Thereafter, the CPU inputs the instructions read from the first E-memory 115 in the foregoing manner and executes them.

The task switchover detection portion 154 writes the currently-executed task number 1 in the retaining portion 155 from the judgment results of the first and second comparison devices 135 and 137, and does not output the instruction rewriting order Sc because the currently-executed task number 1 and the task number of the retaining portion 155 are identical to each other from the judgment results of the first and second comparison devices 135 and 137.

3. Operation when CPU Shifts from Task 1 to Task 2

The CPU outputs the instruction address of the task 2. The judgment result of the first comparison device 135 is negative, while the judgment result of the second comparison device 137 is positive. The second converter 126 converts the instruction address of the CPU into the address for accessing the second E-memory 116. Thereafter, the CPU inputs the instructions read from the second E-memory 116 therein and execute them in the foregoing manner.

The task switchover detection portion 154 outputs the instruction rewriting order Sc to the transmission/reception unit because the currently-executed task number 2 and the task number 1 of the retaining portion 155 are different to each other from the judgment results of the first and second comparison devices 135 and 137. The task switchover detection portion 154 writes the currently-executed task number 2 in the retaining portion 155.

The host, after the receipt of the instruction rewriting order Sc via the transmission/reception unit, transfers the instructions, leading address, and transfer byte number of the task 3 to the writing control portion 129f via the transmission/reception unit. The writing control portion 129f writes the leading address and transfer byte number of the task 3 in the first register 136, and sends out the instructions of the task 3 to the first selector 121. The first E-memory 115 inputs the address therein from the first selector 121, and writes the instructions of the task 3 therein.

As described, according to the present embodiment, the instructions sequences are previously divided per task of the OS in the host so that the instruction sequence per task is transferred to the E-memories to be stored therein. The E-memories are switched over to each other to thereby control the overhead resulting from the transfer traffic and efficiently supply the CPU with the instructions.

In the present embodiment, the leading address of the task is detected in order to detect the switchover of the tasks, thereby switching over and rewriting the E-memories. The E-memories can be switched over to each other in response to a task switchover signal inputted from the CPU or host.

Embodiment 10

In the embodiments 1 through 9, when the program is written in the E-memories in the host, the behavior in the branch of the instructions is analyzed. This generates the overhead resulting from a amount of time consumed for the analysis. An embodiment 10 of the present invention tackles the foregoing problem.

The host is a computer comprised of a debugger software having a function of analyzing the branch information of the instruction sequence executed by the CPU based on a tree construction and memorizing the types and addresses of the branch instructions and the like.

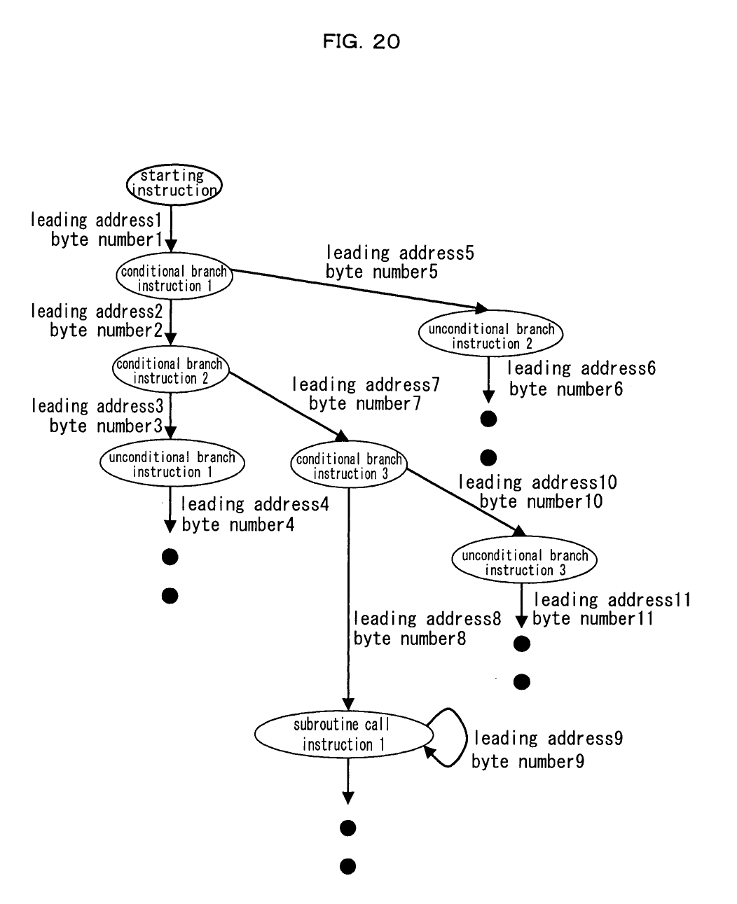

The operations of the debugger apparatus configured in the foregoing manner are described below. FIG. 20 shows the tree construction relating to the branches produced in the host.

1. Operation of Producing Tree Construction Relating to Branch by Host

The host traces all the instructions to be executed from the starting instruction to be first executed. At the time of the tracing, spots, where a disturbance of the program manipulation, such as the conditional branch instruction and unconditional branch instruction, is generated, is detected. Addresses of node parts of the detected spots and byte numbers between the node parts are memorized as the tree construction.

2. Operation Executed by CPU

The host, based on the produced tree construction, transfers a leading address 1 and byte number 1 from the starting address and the instructions therebetween to the execution supervision unit via the transmission/reception unit. The execution supervision unit writes the instructions equivalent to the byte number in the first E-memory 115.

Next, the host, based on the tree construction, transfers a leading address 2 and byte number 2 from the starting address and the instructions therebetween to the execution supervision unit via the transmission/reception unit. The execution supervision unit writes the instructions equivalent to the byte number in the second E-memory 116.

The CPU thereafter fetches the instructions from the first E-memory 115 or second E-memory 116 and executes them in accordance with the operations described in the embodiments 1 through 9.

As described, according to the present embodiment, all the instructions to be executed are previously traced in the host, the spots where the disturbance of the program manipulation are detected, and the addresses of the node parts of the detected spots and byte numbers between the node parts are memorized as the tree construction. This controls the overhead resulting from the analysis of the behavior when the instructions are written, thereby efficiently supplying the CPU with the instructions.

Embodiment 11

In the embodiments 2 through 10, when the instructions are written in the E-memories per branch instruction, some instructions from the issuance of the branch instruction onwards may remain unwritten. Because of that, in using the memory space, a shortage of the memory space is generated in some cases, while the memory space is not used in other cases. Such an imbalance becomes a hindrance for the effective use of the E-memories. An embodiment 11 of the present invention responds with the inconvenience.

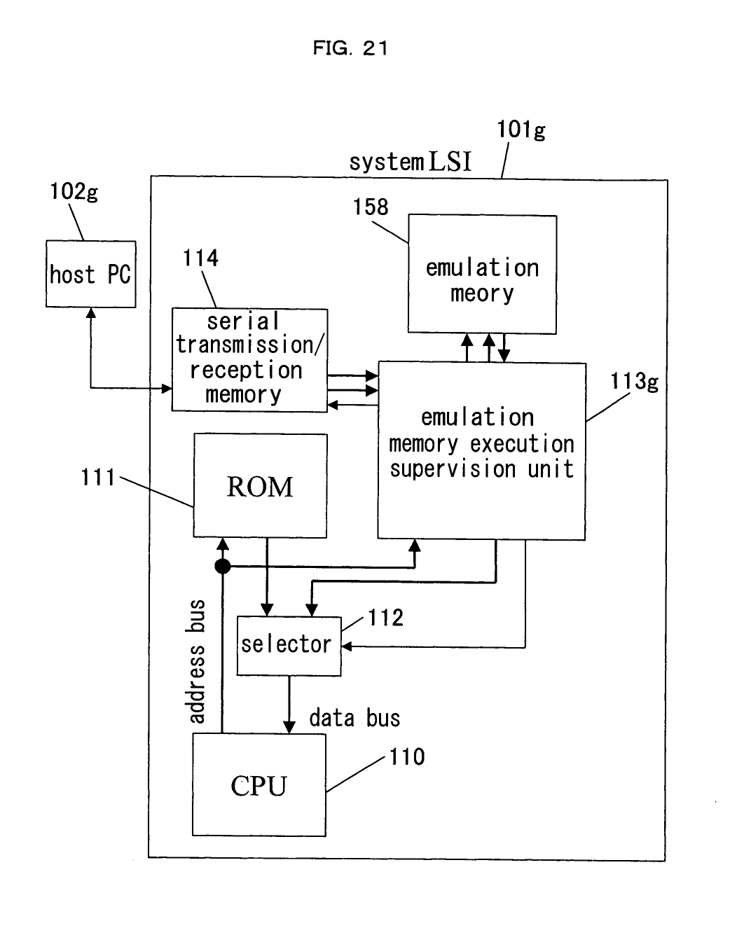

FIG. 21 is a block diagram illustrating a configuration of a debugger apparatus according to the embodiment 11.

A system LSI 101g comprises a single E-memory 158.

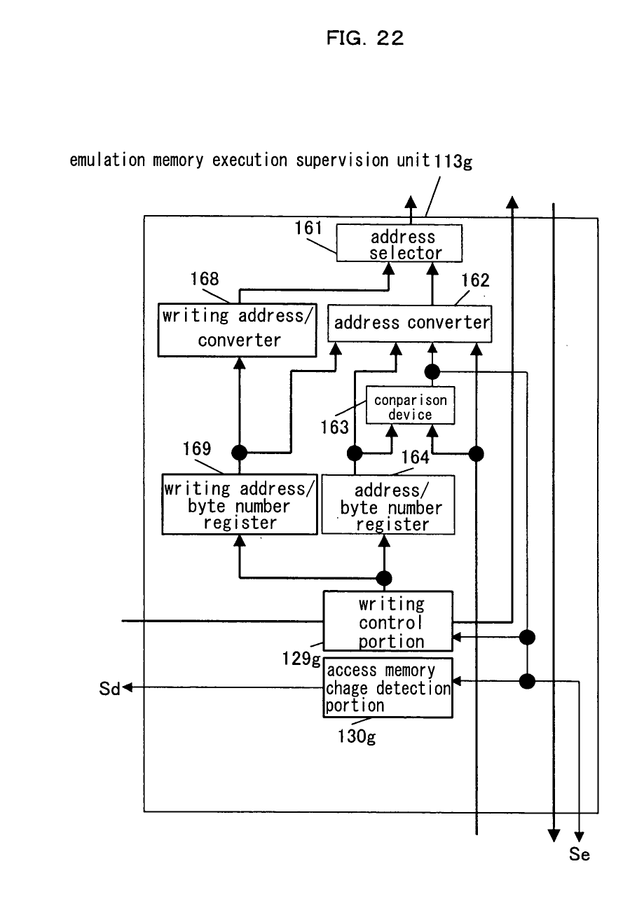

As shown in FIG. 22, an execution supervision unit 113g comprises an address selector 161, address converter 162, comparison device 163, address/byte number register (hereinafter, abbreviated to register) 164, writing control portion 129g, access memory change detection portion 130g, writing address converter 168, and writing address/byte number register (hereinafter, abbreviated to writing register) 169. Because of the provision of the single E-memory 158, the comparison device 163, address converter 162, and address selector 161 are also singularly provided. No data selector and logical sum circuit is provided in the configuration according to the present embodiment.

The writing control portion 129g inputs the instructions, writing leading address, leading address, and transfer byte number of the instruction sequence therein from the transmission/reception unit, and writes the writing leading address for the E-memory in the writing register 169, writes the leading address and transfer byte number in the register 164, and sends out the instructions of the instruction sequence to theE-memory 158. Further, the writing control portion 129g, when the judgment result that the instruction address of the CPU is irrelevant is inputted therein from the comparison device 163, inputs the next leading address and transfer byte number from the transmission/reception unit and writes them in the register 164.

The writing register 169 stores the writing leading address and transfer byte number for the E-memory 158 from the writing control portion 129g therein.

The writing address converter 168 converts the writing address of the writing register 169 into an address for writing with respect to the E-memory 158 based on the corresponding transfer byte number.

The address converter 162, when the judgment result of the comparison device 163 shows positive, converts the instruction address of the CPU into an address for accessing the E-memory 158 based on the writing leading address and transfer byte number of the writing register 169 and the leading address and transfer byte number of the register 164.

The address selector 161 selects the address sent out from the address converter 168 in the case of writing with respect to the E-memory 158, and selects the address sent out from the address converter 162 in any other case.

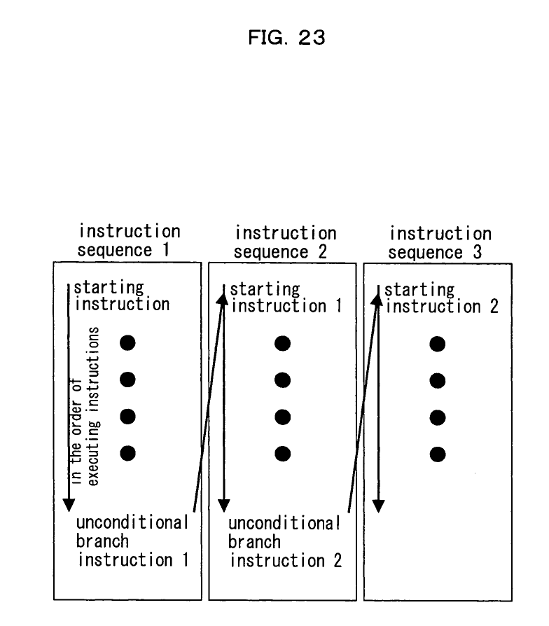

The operations of he debugger apparatus configured in the foregoing manner are described below. FIG. 23 shows instruction sequences transferred from the host 102g.

1. Operation of Writing Instruction in E-Memory

The host traces the instructions, from the starting instruction, according to the execution sequence, and in the presence of the unconditional branch instruction, memorizes the first address traced thereby as the leading address of the instruction sequence 1, and further memorizes the byte number of the instruction sequence as the transfer byte number of the instruction sequence 1. The host also memorizes the leading addresses and transfer by te numbers of the instruction sequences 2, 3, and instruction sequences thereafter.

The host sets the writing leading address with respect to the E-memory to an initial value. The host transfers the instructions, leading address, transfer byte number, and writing leading address of the instruction sequence 1 to the writing control portion 129g.

The writing control portion 129g writes the writing leading address of the instruction sequence 1 in the writing register 169, writes the leading address and transfer byte number of the instruction sequence 1 in the register 164, and transmits the instructions of the instruction sequence 1 to the E-memory 158. The writing address converter 168, based on the leading address and transfer byte number of the instruction sequence 1 of the writing register 169, converts the leading address into the address for writing with respect to the E-memory 158. The E-memory 158 inputs the address from the address selector 161 to thereby write the instructions of the instruction sequence 1 therein.

The instructions of the instruction sequence 2 and instruction sequences thereafter are written in the E-memory 158 in the same manner.

When the writing is completed, the host transfers again the writing leading address of the instruction sequence 1 to the writing control portion 129g via the transmission/reception unit. The writing control portion 129g writes the writing leading address of the instruction sequence 1 in the writing register 169.

2. Operation when Branching by Unconditional Branch Instruction 1

The CPU outputs the instruction address of the instruction sequence 1. In response to the arrival of the unconditional branch instruction 1, the comparison device 163 outputs the judgment result that the instruction address of the CPU does not fall within the transfer byte number from the leading address of the register 164. The change detection portion 130g outputs an address rewriting order Sd to the transmission/reception unit because of the judgment result as negative from the comparison device 163.

As a result, in the steps same as described, the writing leading address, leading address, and transfer byte number of the instruction sequence 2 are now received from the host, the writing leading address of the instruction sequence 2 is written in the writing register 169, and the leading address and transfer byte number of the instruction sequence 2 are written in the register 164.

The comparison device 163 outputs the judgment result that the instruction address of the CPU falls within the transfer byte number from the leading address of the register 164. The address converter 162, since the judgment result of the comparison device 163 shows positive, converts the instruction address of the CPU into the address for accessing the E-memory 158 based on the writing leading address of the writing register 169 and the leading address and transfer byte number of the register 164. The output from the comparison device 163 representing positive constitutes the selection signal Se for the selector 112 to select the output of the execution supervision unit 113g (instruction for reading from the E-memory). Thereafter, the inputs the instructions read from the E-memory 158 and executes them in the same manner.

As described, according to the present embodiment, when the instruction address of the CPU becomes irrelevant, the writing leading address, leading address, and transfer byte number of the next instruction sequence are received from the host. In this manner, the writing with respect to the single E-memory can be executed in the continuous space, thereby effectively using the E-memory.

Embodiment 12

In the embodiment 11, the address and transfer byte number are transferred from the host for each branch, which results in the generation of the overhead. An embodiment 12 of the present invention responds to the problem. In the embodiment 12, FIG. 21 is incorporated therein by reference.

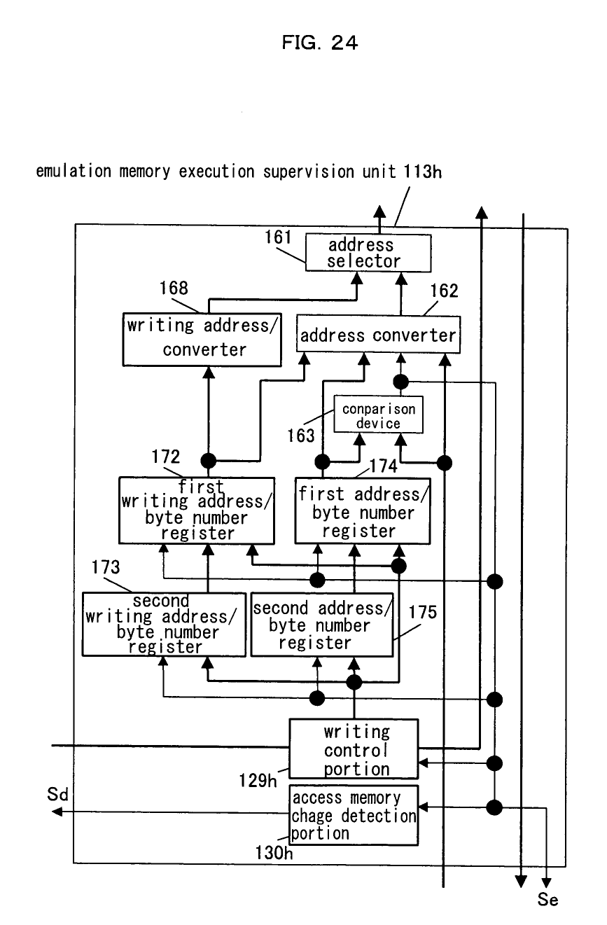

As shown in FIG. 24, an E-memory execution supervision unit 113h comprises a first writing address/byte number register (hereinafter, abbreviated to first writing register) 172, second writing address/byte number register (hereinafter, abbreviated to second writing register) 173, a first address/byte number register (hereinafter, abbreviated to first register) 174, and second address/byte number register (hereinafter, abbreviated to second register) 175. Any other component in FIG. 24, which is identical to the component in FIG. 22, is simply provided with the same reference numeral and not described in the present embodiment.

A writing control portion 129h inputs the instructions, writing leading address with respect to the E-memory, leading address, and transfer byte number of the instruction sequence from the transmission/reception unit therein, and writes the writing leading address with respect to the E-memory in the first writing register 172 or second writing register 173 and writes the leading address and transfer byte number in the first register 174 or second register 175. The writing control portion 129h sends out the instructions of the instruction sequence to the E-memory 158, and, when the judgment result that the instruction address of the CPU is irrelevant is inputted therein from the comparison device 163, inputs the leading address and transfer byte number from the transmission/reception unit therein. The writing control portion 129h writes the writing leading address in the second writing register 173 and writes the leading address and transfer byte number in the second register 175.

The first register 174 renews the content thereof to the values of the second register 175 when the judgment result of the comparison device 163 shows negative.

The first writing register 172 renews the content thereof to the writing leading address and transfer byte number of the second writing register 173 when the judgment result of the comparison device 163 shows negative.

A change detection portion 130h outputs the address rewriting order Sd to the transmission/reception unit when the judgment result of the comparison device 163 shows negative.

The operations of the debugger apparatus configured in the foregoing manner are described below. FIG. 23 shows instruction sequences transferred from the host.

1. Operation of Writing Instruction in E-Memory

The host traces the instructions, from the starting instruction, according to the execution sequence, and in the presence of the unconditional branch instruction, memorizes the first address traced thereby as the leading address of the instruction sequence 1, and further memorizes the byte number of the instruction sequence as the transfer byte number of the instruction sequence 1. The host also memorizes the leading addresses and transfer by te numbers of the instruction sequences 2, 3, and instruction sequences thereafter.

The host sets the writing leading address with respect to the E-memory to the initial value. The host transfers the instructions, writing leading address, leading address, and transfer byte number of the instruction sequence 1 to the writing control portion 129h via the transmission/reception unit.

The writing control portion 129h writes the writing leading address and transfer byte number of the instruction sequence 1 in the first writing register 172, writes the leading address and transfer byte number in the first register 174, and transmits the instructions of the instruction sequence 1 to the address selector 161. The writing address converter 168 converts the writing leading address of the instruction sequence 1 of the first writing register 172 into the address for writing with respect to theE-memory 158 based on the transfer byte number thereof. The E-memory 158 inputs the address from the first address selector 161, and writes the instructions of the instruction sequence 1 therein. The instructions of the instruction sequence 2 and instruction sequences thereafter are written in the E-memory 158 in the same manner.

When the writing is completed, the host transfers the writing leading address, leading address, and transfer byte number of the instruction sequence 1 to the writing control portion 129h via the transmission/reception unit. The writing control portion 129h writes the writing leading address of the instruction sequence 1 in the first writing register 172, and writes the writing leading address of the instruction sequence 2 in the second writing register 173.

1. Operation when Branching by Unconditional Branch Instruction 1

The CPU outputs the instruction address of the instruction sequence 1. Upon the arrival of the unconditional branch instruction 1, the comparison device 163 outputs the judgment result that the instruction address of the CPU does not fall within the transfer byte number from the leading address of the first register 174. Because of the judgment result of the comparison device 163 as negative, the first register 174 renews the content thereof to the values of the second register 175, and the first writing register 172 renews the content thereof to the leading address and byte number of the second writing register 173. Concurrently, the change detection portion 130h, because of the judgment result of the comparison 163 as negative, transmits the address rewriting order Sd to the host via the transmission/reception unit.

As a result of the renewals, the comparison device 163 outputs the judgment result that the instruction address of the CPU falls within the transfer byte number from the leading address of the first register 174. The address converter 162, because the judgment result of the comparison device 163 shows positive, converts the instruction address of the CPU into the address for accessing the E-memory 158 based on the writing leading address of the first writing register 172 and the leading address and transfer byte number of the first register 174. Thereafter, the CPU inputs the instructions read from the E-memory 158 and executes them in the same manner.

Concurrently, the host, after the receipt of the address rewriting order Sd, transfers the instruction, writing leading address, leading address, and transfer byte number of the instruction sequence 3 to the writing control portion 129h via the transmission/reception unit. The writing control portion 129h writes the writing leading address of the instruction sequence 3 in the second writing register 173, and writes the leading address and transfer byte number thereof in the second register 175.

As described, according to the present embodiment, a couple of address/byte number registers and a couple of writing address/byte number registers are respectively provided. In such a configuration, the respective registers renew the contents thereof to the values of the other registers at the time of branching, thereby controlling the overhead resulting from the serial transfer of the address and transfer byte number generated in the branch.

From the above description, it will be apparent what the present invention provides.

1. A debugger apparatus comprising:
a plurality of E-memory units (emulation memory units) the plurality of E-memory units storing instructions executed a CPU; and
an execution supervision unit connected to the CPU, the E-memory units, and the host,
the execution supervision unit individually writing instruction sequences transferred from the host in the plurality of E-memory units, reading an instruction sequence from one of the plurality of E-memory units in accordance with an instruction address of the CPU to thereby transfer the instruction sequence to the CPU, and outputting an instruction rewriting order to the host when the instruction address of the CPU is irrelevant.

2. A debugger apparatus comprising:
a CPU, the CPU executing instructions;
a plurality of E-memory units, the plurality of E-memory units storing the instructions executed by the CPU;
a host, the host tracing the instructions stored in the plurality of E-memory units to thereby transfer the tracing result in the form of an instruction sequence; and
an execution supervision unit connected to the CPU, the E-memory units, and the host, the execution supervision unit individually writing the instruction sequences transferred from the host in the E-memory units, reading an instruction sequence from one of the plurality of E-memory units in accordance with an instruction address of the CPU to thereby transfer the instruction sequence to the CPU, and outputting an instruction rewriting order to the host when the instruction address of the CPU is irrelevant.

3. A debugger apparatus as claimed in claim 2, wherein
the host traces the instructions executed by the CPU according to the execution sequence, and transfers the instruction sequences equivalent to memory capacities of the respective plurality of E-memory units to the execution supervision unit,
the execution supervision unit sequentially writes the instruction sequences transferred from the host equivalent to the memory capacities in the plurality of E-memory units,
the CPU outputs the instruction address to the execution supervision unit,
the execution supervision unit judges whether or not the currently read E-memory unit is different to the previously read E-memory unit in accordance with the instruction address of the CPU,
the execution supervision unit further outputs the instruction rewriting order to the host when the E-memory units are different to each other and reads the instruction sequences from the currently read E-memory unit to thereby transfer the instruction sequences to the CPU,
the CPU executes the instruction sequences transferred from the execution super vision unit,
the host traces the instructions in response to the instruction rewriting order to thereby transfer the next instruction sequence to be executed to the execution supervision unit, and
the execution supervision unit writes the instruction sequences transferred from the host in the previously read E-memory unit per equivalence to a memory capacity thereof.

4. A debugger apparatus comprising:
a CPU, the CPU executing instructions;
a plurality of E-memory units, the plurality of E-memory units storing the instructions executed by the CPU;
a host, the host tracing the instructions stored in the E-memory units to thereby transfer the tracing result in the form of an instruction sequence; and
an execution supervision unit connected to the CPU, the E-memory units, and the host,
the execution supervision unit individually writing the instruction sequences transferred from the host in plurality of the E-memory units, reading an instruction sequence from one of the plurality of E-memory units in accordance with an instruction address of the CPU to thereby transfer the instruction sequence to the CPU, and outputting an instruction rewriting order to the host when the instructions in accordance with the instruction address of the CPU represent the execution of an unconditional branch instruction.

5. A debugger apparatus as claimed in claim 4, wherein
the host traces the instructions executed by the CPU according to the execution sequence, and, in the presence of the unconditional branch instruction, divides the instruction sequences of a branch destination and a branch origin thereof and transfers the instructions per instruction sequence to the execution supervision unit,
the execution supervision unit sequentially writes the instructions transferred from the host per instruction sequence in the plurality of E-memory units,
the CPU outputs an address of the unconditional branch instruction to the execution supervision unit,
the execution supervision unit judges whether or not the currently read E-memory unit by the unconditional branch instruction is different to the previously read E-memory unit in accordance with the instruction address of the CPU,
the execution supervision unit further outputs the instruction rewriting order to the host when the E-memory units are different to each other and reads the unconditional branch instruction from the currently read E-memory unit to thereby transfer the unconditional branch instruction to the CPU,
the CPU executes the unconditional branch instruction transferred from the execution super vision unit,
the host traces the instructions in response to the instruction rewriting order to thereby transfer the next instruction sequence to be executed to the execution supervision unit, and
the execution supervision unit writes the instruction sequences transferred from the host in the previously read E-memory unit per equivalence to a memory capacity thereof.

6. A debugger apparatus as claimed in claim 5, wherein
the host traces the instructions executed by the CPU according to the execution sequence,
the execution supervision unit writes a plurality of instruction sequences, which fit into the same E-memory unit, in the same E-memory unit when the branch destination of the unconditional branch instruction corresponds to a memory region of the same E-memory,
the CPU outputs an address of the unconditional branch instruction to the execution supervision unit, and
the execution supervision unit judges whether or not the currently read E-memory unit by the unconditional branch instruction is the same as the previously read E-memory unit in accordance with the instruction address of the CPU, and the output of the instruction rewriting order is terminated when the E-memories are the same.

7. A debugger apparatus comprising:
a CPU, the CPU executing instructions;
a plurality of E-memory units, the plurality of E-memory units storing the instructions executed by the CPU;
a host, the host tracing the instructions stored in the E-memory units to thereby transfer the tracing result in the form of an instruction sequence; and
an execution supervision unit connected to the CPU, the E-memory units, and the host,
the execution supervision unit individually writing the instruction sequences transferred from the host in the E-memory units, reading an instruction sequence from one of the plurality of E-memory units in accordance with an instruction address of the CPU to thereby transfer the instruction sequence to the CPU, outputting an instruction rewriting order to the host when the instructions in accordance with the instruction address of the CPU represent the execution of an unconditional branch instruction, and terminating the output of the instruction rewriting order when the instructions in accordance with the instruction address of the CPU represent the execution of a subroutine call instruction.

8. A debugger apparatus as claimed in claim 7, wherein
the host traces the instructions executed by the CPU according to the execution sequence, and, in the presence of the subroutine call instruction, divides the instruction sequences including a branch destination and a branch origin thereof and transfers the instructions per instruction sequence to the execution supervision unit,
the execution supervision unit sequentially writes the instructions transferred from the host per instruction sequence in the plurality of E-memory units,
the CPU outputs an address of the subroutine call instruction to the execution supervision unit,
the execution supervision unit judges whether or not the currently read E-memory unit is different to the previously read E-memory unit in accordance with the instruction address of the CPU,
the execution supervision unit further outputs the instruction rewriting order to the host when the E-memory units are different to each other in principle, while terminating the output of the instruction rewriting order in the case of the subroutine call instruction, and reads the subroutine instruction sequence from the currently read E-memory unit to thereby transfer the subroutine instruction sequence to the CPU, and
the CPU executes the subroutine instruction sequence transferred from the execution super vision unit.

9. A debugger apparatus comprising:
a CPU, the CPU executing instructions;
a plurality of E-memory units, the plurality of E-memory units storing the instructions executed by the CPU;
a host, the host tracing the instructions stored in the E-memory units to thereby transfer the tracing result in the form of an instruction sequence; and
an execution supervision unit connected to the CPU, the E-memory units, and the host,
the execution supervision unit individually writing the instruction sequences transferred from the host in the plurality of E-memory units, reading an instruction sequence from one of the plurality of E-memory units in accordance with an instruction address of the CPU to thereby transfer the instruction sequence to the CPU, and outputting an instruction rewriting order to the host when the instructions in accordance with the instruction address of the CPU represent the execution of an unconditional branch instruction, while terminating the output of the instruction rewriting order when the instructions in accordance with the instruction address of the CPU represent the execution of an exception processing.

10. A debugger apparatus as claimed in claim 9, wherein
the host traces the instructions executed by the CPU according to the execution sequence, and, in the presence of the exception processing, divides the instruction sequences including a branch destination and a branch origin thereof and transfers the instructions per instruction sequence to the execution supervision unit,
the execution supervision unit sequentially writes the instructions transferred from the host per instruction sequence in the plurality of E-memory units,
the CPU outputs an address of the exception processing to the execution supervision unit,
the execution supervision unit judges whether or not the currently read E-memory unit is different to the previously read E-memory unit in accordance with the instruction address of the CPU,
the execution supervision unit further outputs the instruction rewriting order to the host when the E-memory units are different to each other in principle, while terminating the output of the instruction rewriting order in the case of the exception processing, and reads the exception processing from the currently read E-memory unit to thereby transfer the exception processing to the CPU, and
the CPU executes the exception processing transferred from the execution supervision unit.

11. A debugger apparatus comprising:
a CPU, the CPU executing instructions;
a plurality of E-memory units, the plurality of E-memory units storing the instructions executed by the CPU;
a host, the host tracing the instructions stored in the E-memory units to thereby transfer the tracing result in the form of an instruction sequence; and
an execution supervision unit connected to the CPU, the E-memory units, and the host,
the execution supervision unit individually writing the instruction sequences transferred from the host in the plurality of E-memory units, reading an instruction sequence from one of the plurality of E-memory units in accordance with an instruction address of the CPU to thereby transfer the instruction sequence to the CPU,
the execution supervision unit judging whether or not a branch is established when the instructions in accordance with the instruction address of the CPU represent the execution of a conditional branch instruction, and outputting the instruction rewriting order to the host when the branch is established.

12. A debugger apparatus as claimed in claim 11, wherein
the host traces the instructions executed by the CPU according to the execution sequence, and, in the presence of the conditional branch instruction, divides the instruction sequences including a branch destination and a branch origin thereof and transfers the instructions per instruction sequence to the execution supervision unit,
the execution supervision unit sequentially writes the instructions transferred from the host per instruction sequence in the plurality of E-memory units,
the CPU outputs an address of the conditional branch instruction to the execution supervision unit,
the execution supervision unit judges whether or not the branch by the conditional branch instruction is established, and further judges whether or not a currently read E-memory unit by the conditional branch instruction is different to the previously read E-memory unit in accordance with the instruction address of the CPU,
the execution supervision unit further outputs the instruction rewriting order to the host when the E-memory units are different to each other and reads the conditional branch instruction from the currently read E-memory unit to thereby transfer the conditional branch instruction to the CPU, while outputting a next instruction rewriting order of the conditional branch instruction to the host when the conditional branch instruction is failed,
the CPU executes the conditional branch instruction transferred from the execution supervision unit,
the host traces the instructions in response to the instruction rewriting order and also traces the instructions in response to the next instruction rewriting order to thereby respectively transfer the next instruction sequences to be executed to the execution supervision unit, and
the execution supervision unit writes the instruction sequences transferred from the host in the previously read E-memory unit per equivalence to a memory capacity thereof.

13. A debugger apparatus as claimed in claims 11 or 12, wherein
the host traces the instructions executed by the CPU according to the execution order and implements a simulation to the traced instructions, and further predicts if the branch is established or failed when the simulation result shows the presence of the conditional branch instruction and terminates the transfer of the instruction sequence of the branch destination with respect to the execution supervision unit when it is predicted that the branch is failed.

14. A debugger apparatus comprising:
a CPU, the CPU executing instructions;
a plurality of E-memory units, the plurality of E-memory units storing the instructions executed by the CPU;
a host, the host tracing the instructions stored in the E-memory units to thereby transfer the tracing result in the form of an instruction sequence, and further possibly transferring the instruction sequences including a plurality of conditional branch instructions; and
an execution supervision unit connected to the CPU, the E-memory units, and the host,
the execution supervision unit individually writing the instruction sequences transferred from the host in the plurality of E-memory units, reading an instruction sequence from one of the plurality of E-memory units in accordance with an instruction address of the CPU to thereby transfer the instruction sequence to the CPU,
the execution supervision unit judging whether or not the branch is established when the instructions in accordance with the instruction address of the CPU represent the execution of a first conditional branch instruction of the plurality of conditional branch instructions, and outputting an instruction rewriting order to the host when the branch is established and terminating the output of the instruction rewriting order when the branch is failed.

15. A debugger apparatus as claimed in claim 14, wherein
the host traces the instructions executed by the CPU according to the execution sequence, and, in the presence of the plurality of conditional branch instructions, divides the instruction sequences including a plurality of branch destinations and a branch origin and transfers the instructions per instruction sequence to the execution supervision unit,
the execution supervision unit sequentially writes the instructions transferred from the host per instruction sequence in the plurality of E-memory units,
the CPU outputs an address of the first conditional branch instruction to the execution supervision unit,
the execution supervision unit judges whether or not the branch by the first conditional branch instruction is established, and further judges whether or not the currently read E-memory unit by the first unconditional branch instruction is different to the previously read E-memory unit in accordance with the instruction address of the CPU,
the execution supervision unit further outputs the instruction rewriting order to the host when the E-memory units are different to each other and reads the first conditional branch instruction from the currently read E-memory unit to thereby transfer the first conditional branch instruction to the CPU, while outputting the next instruction rewriting order of the first conditional branch instruction when the first conditional branch instruction is failed,
the CPU executes the first conditional branch instruction transferred from the execution supervision unit,
the host traces the instructions in response to the instruction rewriting order and also traces the instructions in response to the next instruction rewriting order and also traces the instructions in response to the next instruction rewriting order to thereby respectively transfer the next instruction sequences to be executed to the execution supervision unit,
the execution supervision unit writes the instruction sequences transferred from the host in the previously read E-memory unit per equivalence to a memory capacity thereof,
the CPU outputs an address of a second conditional branch instruction to the execution supervision unit, and
the execution supervision unit executes the foregoing processing depending on the establishment or failure of the branch by the second conditional branch instruction.

16. A debugger apparatus comprising:
a CPU, the CPU executing instructions;
a plurality of E-memory units, the plurality of E-memory units storing the instructions executed by the CPU;
a host, the host tracing the instructions stored in the E-memory units to thereby transfer the tracing result in the form of an instruction sequence; and
an execution supervision unit connected to the CPU, the E-memory units, and the host,
the execution supervision unit individually writing the instruction sequences of tasks transferred from the host in the plurality of E-memory units, reading an instruction sequence of a task from one of the plurality of E-memory units in accordance with an instruction address of the CPU to thereby transfer the instruction sequence of the task to the CPU, and outputting an instruction rewriting order to the host when the instructions in accordance with the instruction address of the CPU represent the execution of a switchover of tasks.

17. A debugger apparatus as claimed in claim 16, wherein
the host traces the instructions executed by the CPU according to the execution sequence, and, in the presence of the task switchover, divides the instruction sequences of a branch destination and a branch origin and transfers the instructions per task to the execution supervision unit,
the execution supervision unit sequentially writes the instructions transferred from the host per task in the plurality of E-memory units,
the CPU outputs an instruction address of the task switchover to the execution supervision unit,
the execution supervision unit judges whether or not the E-memory unit of the branch destination of the task switchover is the same as the previously read E-memory unit in accordance with the instruction address of the CPU, and outputs the instruction rewriting order to the host when the E-memory units are different to each other and reads the instruction sequences of the tasks from the currently read E-memory unit to thereby transfer the instruction sequences of the tasks to the CPU,
the CPU executes the instruction sequences of the tasks transferred from the execution supervision unit,
the host traces the instructions in response to the instruction rewriting order to thereby transfer the next instruction sequence of the task to be executed to the execution supervision unit,
the execution supervision unit writes the instruction sequences of the tasks transferred from the host in the previously read E-memory unit per equivalence to a memory capacity thereof.

18. A debugger apparatus as claimed in claim 13, wherein
the host traces the instructions executed by the CPU according to the execution order to thereby produce an execution tree construction,
the host divides the instruction sequences of the branch destination and the branch origin of the branch instruction based on the tree construction and transfers the instructions per instruction sequence to the execution supervision unit, and
the execution supervision unit sequentially writes the instructions transferred from the host per instruction sequence in the plurality of E-memory units.

19. A debugger apparatus comprising:
a CPU, the CPU executing instructions;
a single E-memory unit, the single E-memory unit storing the instructions executed by the CPU;
a host, the host tracing the instructions stored in the E-memory units to thereby transfer the tracing result in the form of an instruction sequence together with a writing leading address; and
an execution supervision unit connected to the CPU, the E-memory unit, and the host,
the execution supervision unit retaining the writing leading address transferred from the host, writing the instruction sequences transferred from the host in the E-memory unit in accordance with the writing leading address, retaining the writing leading address and a leading instruction address transferred from the host, converting the instruction address of the CPU into an address for accessing the E-memory based on the writing leading address and the leading instruction address, and reading the instructions from the E-memory in accordance with the converted address to thereby transfer the instructions to the CPU,
the execution supervision unit outputting an address rewriting order to the host when the instructions in accordance with an instruction address of the CPU represent the execution of a branch instruction, and retaining a writing leading address and a leading instruction address of the next instruction to be executed transferred from the host in response to the address rewriting order.

20. A debugger apparatus as claimed in claim 19, wherein
the host traces the instructions executed by the CPU according to the execution sequence, and, in the presence of the branch instruction, divides the instruction sequences of a branch destination and a branch origin thereof to thereby transfer the instructions per instruction sequence and the writing leading address thereof to the execution supervision unit,
the execution supervision unit writes the instructions transferred from the host per instruction sequence in the E-memory in accordance with the writing leading address, and retains the leading instruction address,
the CPU outputs an address of the branch instruction to the execution supervision unit,
the execution supervision unit judges whether or not the address of the branch instruction is different to the current leading instruction address in accordance with the address of the branch instruction of the CPU, and outputs the address rewriting order to the host when the addresses are different to each other,
the host traces the instructions in response to the address rewriting order and transfers the writing leading address and the leading instruction address of the next instruction sequence to be executed to the execution supervision unit, and
the execution supervision unit retains the writing leading address and the leading instruction address transferred from the host.

21. A debugger apparatus comprising:
a CPU, the CPU executing instructions;
a single E-memory unit, the single E-memory unit storing the instructions executed by the CPU;
a host, the host tracing the instructions stored in the E-memory units to thereby transfer the tracing result in the form of an instruction sequence together with a writing leading address; and
an execution supervision unit connected to the CPU, the E-memory unit, and the host,
the execution supervision unit retaining the writing leading address transferred from the host, writing the instruction sequence transferred from the host in the E-memory unit in accordance with the writing leading address, retaining the writing leading address and a leading instruction address transferred from the host, and retaining a writing leading address and a leading instruction address of the next instruction address,
the execution supervision unit converting the instruction address of the CPU into an address for accessing the E-memory based on the writing leading address and the leading instruction address, reading the instructions from the E-memory in accordance with the converted address to thereby transfer the instructions to the CPU,
the execution supervision unit replacing the current writing leading address with the writing leading address of the next instruction sequence and further replacing the current leading instruction address with the leading instruction address of the next instruction sequence when the instructions in accordance with the instruction address of the CPU represent the execution of a branch instruction, outputting an address rewriting order to the host, and retaining a writing leading address and a leading instruction address of a next instruction sequence to be executed transferred from the host in response to the address rewriting order as an object of a next processing.
